(19) United States
(12) Patent Application Publication
(10) Pub. No.: US 2010/0246191 A1
(43) Pub. Date: Sep. 30, 2010

(54) OPTICAL SHEET AND METHOD FOR PRODUCING THE SAME

(76) Inventors: Shotaro Ogawa, Minami-Ashigara-shi (JP); Yoshihisa Usami, Minami-Ashigara-shi (JP)

Correspondence Address: BIRCH STEWART KOLASCH & BIRCH, PO BOX 747, FALLS CHURCH, VA, 22040-0747, US

(21) Appl. No.: 12/724,851

(22) Filed: Mar. 16, 2010

(30) Foreign Application Priority Data
Mar. 25, 2009 (JP) 2009-075065

(51) Int. Cl. F21V 13/04; B29C 41/22

(52) U.S. Cl. 362/309; 156/243

(57) ABSTRACT

An optical sheet including a first layer having a concavo-convex pattern which reflects light, and a second layer laminated over the concavo-convex pattern and made of a light-transmissive material, wherein the optical sheet is disposed opposite to a light-emitting surface of a light-emitting element.

### BACKGROUND OF THE INVENTION

1. Field of the Invention

The present invention relates to an optical sheet used in an optical element containing a high-refractive-index illuminant such as an organic EL element and to a method for producing the optical sheet.

2. Description of the Related Art

In devices in which light is emitted outside from an inside illuminator having a high refractive index (e.g., organic EL displays), when emitted at a large angle from the inside illuminator, light is totally reflected on the interface with respect to a layer having a lower refractive index (e.g., a transparent glass substrate). Further, regardless of the angle at which light is emitted, the light is reflected on the interface. As a result, the emitted light is confined inside and is difficult to extract, leading to a drop in light-emitting efficiency.

In view of this, there have been proposed light-emitting elements having various structures for improving light-extraction efficiency.

One proposed organic electroluminescence element includes an anode, a cathode, one or more organic layers containing a light-emitting layer disposed between the electrodes and a diffracting grating or a zone plate, wherein the diffracting grating or the zone plate is disposed in position for preventing total reflection on the interface in the element (see Japanese Patent (JP-B) No. 2991183).

However, in the above structure, the emitted light passes through low-refractive-index layers before reaches the diffracting grating or the zone plate, problematically limiting the prevention of total reflection.

Another proposed light-emitting device contains a concavo-convex patterned scattering layer at a back surface opposite to a light-emitting surface, wherein the scattering layer reflects/scatters light, having been emitted through an intermediate layer from a light-emitting layer, toward the light-emitting surface for light extraction (see Norihiko Kamiura, four others “Studies on OLED Light Extraction Enhancement” edited by THE INSTITUTE OF ELECTRONICS, INFORMATION AND COMMUNICATION ENGINEERS, TECHNICAL REPORT OF IEICE, EID2007-102, OME2007-84 (2008-03), pp. 1 to 4; and Hiroshi Sano, 12 others “An Organic Light-Emitting Diode with Highly Efficient Light Extraction Using Newly Developed Diffraction Layer,” SID 08 DIGEST, pp. 515 to 517).

However, in the above structure, the extraction efficiency of the light emitted from the light-emitting layer is not still satisfactory due to total reflection.

### BRIEF SUMMARY OF THE INVENTION

The present invention solves the above existing problems and achieves the following objects. Specifically, the present invention aims to provide an optical sheet which improves light-extraction efficiency of an optical element and a method for producing the optical sheet.

Means for solving the above existing problems are as follows.

<1> An optical sheet including:

a first layer having a concavo-convex pattern which reflects light, and

a second layer laminated over the concavo-convex pattern and made of a light-transmissive material,

wherein the optical sheet is disposed opposite to a light-emitting surface of a light-emitting element.

<2> The optical sheet according to <1> above, wherein the difference in refractive index between the second layer and a light-emitting layer of the light-emitting element is within 0.3.

<3> The optical sheet according to one of <1> and <2> above, wherein the pitch of the concavo-convex pattern is 100 nm to 5,000 nm.

<4> The optical sheet according to any one of <1> to <3> above, wherein the second layer contains a metal oxide dispersed therein.

<5> The optical sheet according to any one of <1> to <4> above, wherein the aspect ratio of convex portions in the concavo-convex pattern is 0.1 to 4.0.

<6> The optical sheet according to any one of <1> to <5> above, further including a support film disposed on the outer surface of the second layer.

<7> A method for producing the optical sheet according to any one of <1> to <6> above, the method including:

coating a support film with a curable resin which is a light-transmissive material,

forming a second layer by curing the curable resin while a mold having a concavo-convex pattern in a surface thereof is being pressure-bonded to the curable resin, and

forming a first layer by forming a thin film of a reflective material on the second layer.

<8> The method according to <7> above, wherein the support film is a belt-like film and the mold is a first roll mold having a concavo-convex pattern in an outer circumferential surface thereof, and wherein, in the coating, the belt-like film continuously coated with the curable resin and, in the forming the second layer, the belt-like film which has been coated with the curable resin is wound around the first roll mold.

<9> The method according to <8> above, further including forming a laminate containing the first layer by coating a surface of the thin film with a resin-containing coating liquid, wherein, in the forming the laminate, the belt-like film is provided with a thin film of a reflective material and wound around a second roll mold having a smooth outer circumferential surface which has been coated with the resin-containing coating liquid.

<10> A method for producing the optical sheet according to any one of <1> to <6> above, the method including:

forming a first layer by forming a concavo-convex pattern in a light-reflective sheet superposed on and thermally pressure-bonded to a surface of a mold having the concavo-convex pattern, and

forming a second layer by coating a surface of the first layer with a resin-containing coating liquid containing a resin as a light-transmissive material.

<11> The method according to <10> above, wherein the light-reflective sheet is a belt-like sheet and the mold is a first roll mold having a concavo-convex pattern in an outer circumferential surface thereof, and wherein, in the forming the first layer, the belt-like sheet is wound around the first roll mold and continuously provided with a concavo-convex pattern to thereby form the first layer and, in the forming the second layer, a surface of the first layer is continuously coated with the resin-containing coating liquid.

<12> The method according to <11> above, wherein, in the forming the second layer, the belt-like film is wound around a second roll mold having a smooth outer circumferential surface which has been coated with the resin-containing coating liquid.

<13> The method according to any one of <10> to <12> above, further including attaching a support film to the second layer.

<14> A method for producing the optical sheet according to any one of <1> to <6> above, the method including:

forming a concavo-convex pattern in a surface of a support film while a mold having the concavo-convex pattern is being pressure-bonded to the surface of the support film,

forming a first layer by forming a thin film of a reflective material on the concavo-convex pattern, and

forming a second layer by coating a surface of the first layer with a resin-containing coating liquid containing a resin as a light-transmissive material.

<15> The method according to <14> above, wherein the support film is a belt-like film and the mold is a first roll mold having a concavo-convex pattern in an outer circumferential surface thereof, and wherein, in the forming the concavo-convex pattern, the belt-like film is wound around the first roll mold and continuously provided with a concavo-convex pattern and, in the forming the first layer, a thin film of a reflective material is formed on the concavo-convex pattern to thereby form the first layer.

<16> The method according to <15> above, wherein, in the forming the second layer, the belt-like film is wound around a second roll mold having a smooth outer circumferential surface which has been coated with the resin-containing coating liquid.

<17> The method according to any one of <14> to <16> above, further including attaching a support film to the second layer.

The present invention can provide an optical sheet which improves light-extraction efficiency of an optical element and a method for producing the optical sheet. These can solve the above existing problems and achieve the above objects.

### BRIEF DESCRIPTION OF THE DRAWINGS

FIG. 1 is a schematic view for explaining one exemplary optical sheet of the present invention.

FIG. 2 is a schematic view for explaining another exemplary optical sheet of the present invention.

FIG. 3A is a schematic view for explaining a step of one exemplary method of the present invention for producing an optical sheet (part 1).

FIG. 3B is a schematic view for explaining a step of one exemplary method of the present invention for producing an optical sheet (part 2).

FIG. 3C is a schematic view for explaining a step of one exemplary method of the present invention for producing an optical sheet (part 3).

FIG. 3D is a schematic view for explaining a step of one exemplary method of the present invention for producing an optical sheet (part 4).

FIG. 3E is a schematic view for explaining a step of one exemplary method of the present invention for producing an optical sheet (part 5).

FIG. 4 is a schematic view for explaining one exemplary manner in which an optical sheet of the present invention is attached to a substrate.

FIG. 5A is a schematic view for explaining one exemplary Roll to Roll production system used for a method of the present invention for producing an optical sheet.

FIG. 5B is a schematic view for explaining another exemplary Roll to Roll production system used for a method of the present invention for producing an optical sheet (part 1).

FIG. 5C is a schematic view for explaining another exemplary Roll to Roll production system used for a method of the present invention for producing an optical sheet (part 2).

FIG. 6A is a schematic view for explaining another exemplary method of the present invention for producing an optical sheet (part 1).

FIG. 6B is a schematic view for explaining another exemplary method of the present invention for producing an optical sheet (part 2).

FIG. 6C is a schematic view for explaining another exemplary method of the present invention for producing an optical sheet (part 3).

FIG. 6D is a schematic view for explaining another exemplary method of the present invention for producing an optical sheet (part 4).

FIG. 7 is a schematic view for explaining one exemplary manner in which an optical sheet of the present invention is disposed.

FIG. 8 is a schematic view for explaining the pitch of a concavo-convex pattern and the aspect ratio of convex portions in an optical sheet of the present invention.

FIG. 9 is a schematic top view for explaining the pitch of a concavo-convex pattern in an optical sheet of the present invention.

### DETAILED DESCRIPTION OF THE INVENTION

Next will be described in detail an optical sheet of the present invention and a method for producing the optical sheet.

### (Optical Sheet)

An optical sheet of the present invention includes at least a first layer and a second layer; and, if necessary, further includes other members.

### <First Layer>

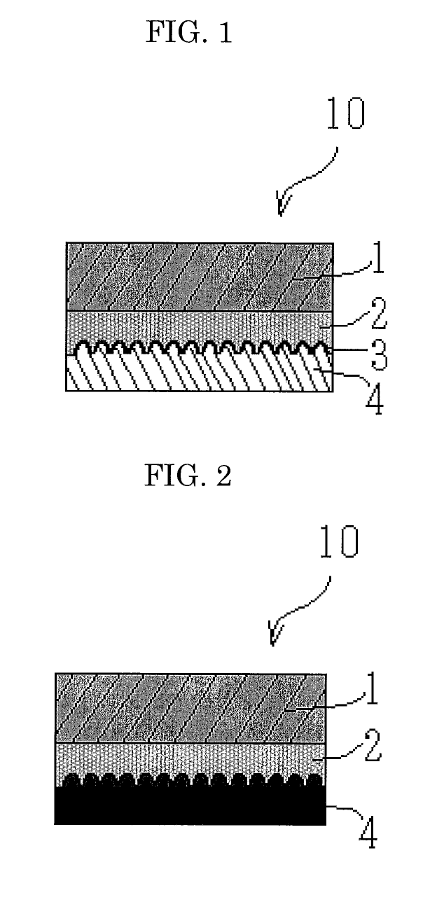

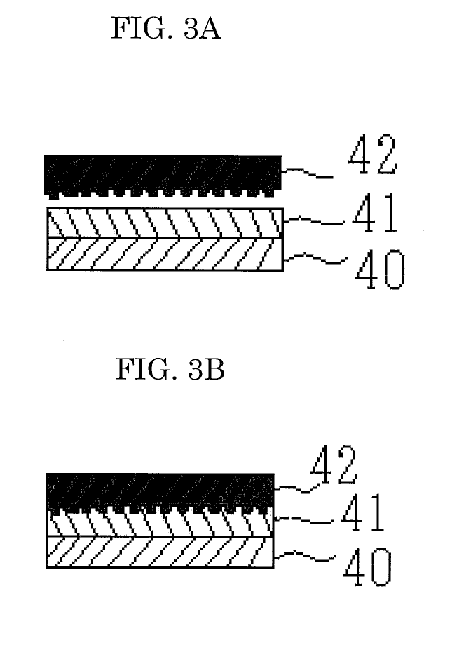

The first layer is not particularly limited, so long as it has a concavo-convex pattern, and may be appropriately selected depending on the purpose. The first layer is, for example, a laminate (consisting of layers indicated by reference numerals 3 and 4 in FIG. 1) or a light-reflective member (indicated by reference numeral 4 in FIG. 2).

The laminate is not particularly limited and may be appropriately selected depending on the purpose. Examples thereof include those composed of a resin layer and a thin film made of a reflective material.

The light-reflective member is not particularly limited and may be appropriately selected depending on the purpose. Examples thereof include metallic luster sheets having a concavo-convex pattern in their surfaces.

### <<Concavo-Convex Pattern>>

The concavo-convex pattern is not particularly limited, so long as it reflects light, and may be appropriately selected depending on the purpose. For example, the concavo-convex pattern is formed from a thin film made of a light-reflective and formed in a surface of a metallic luster film.

The shape of the concavo-convex pattern is not particularly limited, so long as the concavo-convex pattern extends in a streaky shape or is sparsely arranged, for example, and may be appropriately determined depending on the purpose. Among them, preferably, the concavo-convex pattern is sparsely arranged.

The concavo-convex pattern may have any pitch P, so long as it can enhance the light-emitting efficiency. The pitch may be appropriately determined depending on the purpose, material and structure, and is preferably 100 nm to 5,000 nm, more preferably 300 nm to 2,000 nm.

When the pitch P of the concavo-convex pattern is less than 100 nm, it is difficult to form a concavo-convex pattern, potentially leading to a drop in productivity. When the pitch is more than 5,000 nm, the enhancement in light-emitting efficiency commensurate with the pitch cannot be attained in some cases.

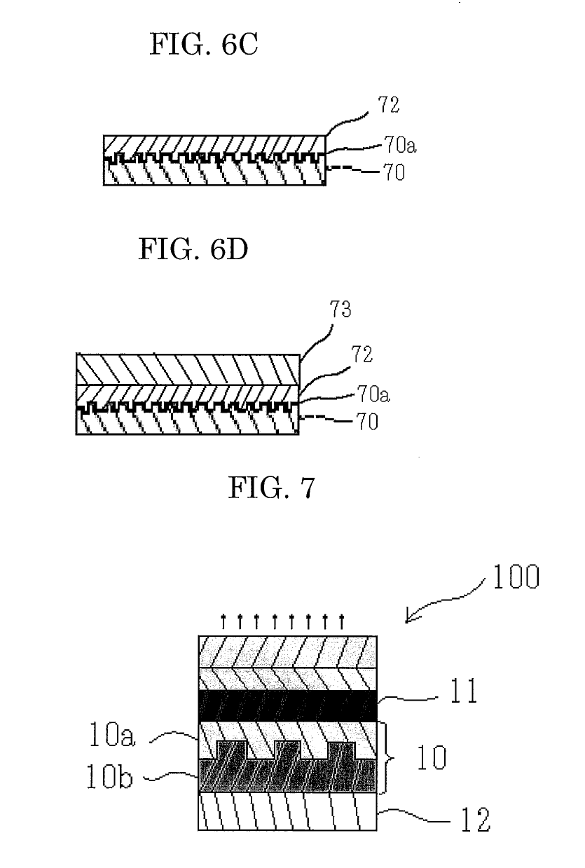

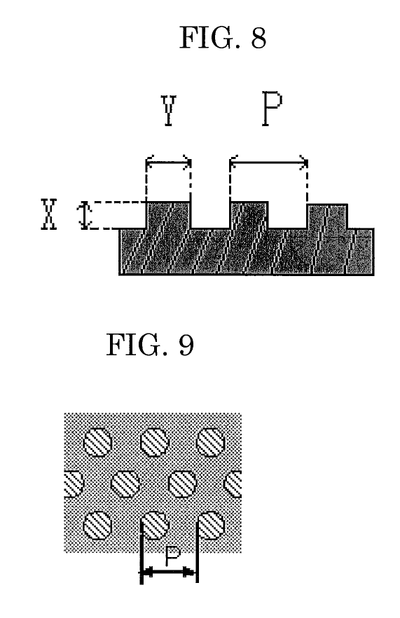

Notably, the pitch P of the concavo-convex pattern is a period of concave and convex portions as shown in FIGS. 8 and 9.

The convex portion of the concavo-convex pattern has any aspect ratio X/Y, so long as the concavo-convex pattern can enhance light-emitting efficiency. The aspect ratio of the convex portion may be determined depending on the purpose, material and structure, and is preferably 0.1 to 4.0, more preferably 0.2 to 2.0, particularly preferably 0.3 to 1.0.

When the aspect ratio X/Y of the convex portion is less than 0.1, the enhancement in light-emitting efficiency commensurated with the aspect ratio cannot be attained in some cases. When the aspect ratio is more than 4.0, it is difficult to form a concavo-convex pattern, potentially leading to a drop in productivity.

As shown in FIG. 8, the aspect ratio of the convex portion in the concavo-convex pattern is an average value of ratios X/Y of the heights X to the widths Y of 10 convex portions.

### <Second Layer>

The second layer contains at least a light-transmissive material; and, if necessary, further contains a metal oxide and other components.

The light-transmissive material is not particularly limited, so long as it can be cured in a molten state, and may be appropriately selected depending on the purpose. Examples thereof include photocurable resins, thermoplastic resins and thermosetting resins.

The photocurable resins are not particularly limited and may be appropriately selected depending on the purpose. Examples thereof include unsaturated polyester resins, polyester acrylate resins, urethane acrylate resins, silicone acrylate resins and epoxy acrylate resins. If necessary, these resins may be mixed with, for example, a photoinitiator before use.

The thermoplastic resins are not particularly limited and may be appropriately selected depending on the purpose. Examples thereof include polyethylenes, polyesters, polystyrenes and polycarbonates.

The thermosetting resins are not particularly limited and may be appropriately selected depending on the purpose. Examples thereof include silicone resins, phenoxy resins and epoxy resins.

The light-transmissive material preferably contains, for example, an adhesion component, from the viewpoint of enhancing adhesion to a light-emitting element described below. But, the light-transmissive material may not contain an adhesion component, so long as the light-transmissive material can optically adhere to the light-emitting element.

The metal oxide is not particularly limited and may be appropriately selected depending on the purpose. Examples thereof include titanium oxide, germanium oxide, zirconium oxide, zinc oxide, cerium oxide, tin oxide and antimony oxide. By dispersing the metal oxide in the second layer, the refractive index of the second layer can be increased.

The refractive index of the second layer is not particularly limited and may be appropriately determined depending on the purpose and material. When the second layer is used in an organic EL element containing a high-refractive-index light-emitting layer (refractive index: 1.7 to 2.0, for example) and a low-refractive-index transparent substrate (refractive index: 1.4 to 1.6, for example) which is bound to the light-emitting layer, the refractive index thereof is preferably 1.7 to 2.0, and the difference in refractive index between the second layer and the light-emitting layer is more preferably within 0.3, particularly preferably within 0.1.

When the difference in refractive index therebetween is greater than 0.3, the enhancement in light-emitting efficiency commensurate with the difference cannot be attained in some cases.

Notably, the refractive index is measured through ellipsometry with, for example, an Abbe refractometer (product of ATAGO CO., LTD.).

The manner in which the second layer is disposed is not particularly limited, so long as the second layer is disposed on the concavo-convex pattern, and may be appropriately selected depending on the purpose.

### <Other Members>

The other members are not particularly limited and may be appropriately selected depending on the purpose. Examples thereof include a support film.

### <<Support Film>>

The support film is not particularly limited, so long as it is disposed on the outer surface of at least the second layer (it may be disposed on the outer surfaces of the first and second layers), and may be appropriately selected depending on the purpose. Examples thereof include support films having releasability and plasticity, such as a polyethylene film, a polyethylene terephthalate film and a polypropylene film.

The support film having releasability is readily peeled off from the second layer, allowing the optical sheet to easily adhere to a target object. The support film having plasticity allows the optical sheet to be wound for transportation and storage, and to easily adhere to a target object.

The thickness of the support film is not particularly limited and may be appropriately determined depending on the purpose. It is preferably 50 μm to 200 μm in terms of handleability and cost. When the thickness is smaller than 50 μm, the rigidity of the support film is low, potentially making it difficult to treat (handle) the optical sheet. When the thickness is greater than 200 μm, the rigidity of the support film is too high, leading to a drop in flexibility and to cost elevation. Notably, the thickness of the support film is preferably smaller in terms of transmittance.

As shown in FIG. 1, the optical sheet may include a first layer 4 having a concavo-convex pattern 3, a second layer 2 disposed on the concavo-convex pattern 3, and a support film 1 formed on the second layer 2. Also, as shown in FIG. 2, the optical sheet may include a first layer 4 having a concavo-convex pattern in its surface, a second layer 2 disposed on the concavo-convex pattern, and a support film 1 formed on the second layer 2.

### (Method for Producing Optical Sheet)

### First Embodiment

In a first embodiment, the method of the present invention for producing an optical sheet includes at least a coating step, a second layer-forming step and a first layer-forming step; and, if necessary, further includes a laminate forming step and other steps.

### <<Coating Step>>

The coating step is a step of coating a support film with a curable resin as a light-transmissive material.

The support film and the curable resin are previously described.

The thickness of the curable resin coated is not particularly limited and may be appropriately determined depending on the purpose. It is preferably 3 μm to 30 μm.

The method for coating the curable resin is not particularly limited and may be appropriately selected depending on the purpose. Examples thereof include extrusion coating, bar coating, gravure coating and roll coating.

### <<Second Layer-Forming Step>>

The second layer-forming step is a step of forming a second layer by curing the curable resin while a mold having a concavo-convex pattern in a surface thereof is being pressure-bonded to the curable resin. By pressure-bonding the mold to the curable resin, the concavo-convex pattern of the mold can be transferred to the curable resin.

The mold is not particularly limited, so long as it has a concavo-convex pattern in a surface thereof, and may be appropriately selected depending on the purpose.

The method for forming the concavo-convex pattern in the mold is not particularly limited and may be appropriately selected depending on the purpose. Examples thereof include electron beam (EB) lithography/etching and laser lithography. Among them, laser lithography is preferred since it can be used for a large-area original plate and a roll-shaped original plate.

The method for curing the curable resin is not particularly limited and may be appropriately selected depending on the purpose. Examples thereof include UV irradiation and heating.

When the support film is transparent, UV irradiation can be performed through the support film. When the mold is transparent, UV irradiation can be performed through the mold.

The heating temperature is not particularly limited and may be appropriately determined depending on the purpose.

### <<First Layer-Forming Step>>

The first layer-forming step is a step of forming a first layer by forming a thin film of a reflective material on the second layer.

The reflective material is not particularly limited and may be appropriately selected depending on the purpose. Examples thereof include silver, aluminum and nickel.

The thickness of the thin film is not particularly limited and may be appropriately determined depending on the purpose. It is preferably 10 nm to 100 nm.

When the thickness of the thin film is smaller than 10 nm, the thin film may be broken. Whereas when the thickness of the thin film is larger than 100 nm, the pitch of the concavo-convex pattern may be affected.

The method for forming the film is not particularly limited and may be appropriately selected depending on the purpose. Examples thereof include vapor deposition and sputtering. In particular, for example, preferred is a method using atmospheric-pressure plasma, since the method can be performed under atmospheric pressure.

### <<Laminate Forming Step>>

The laminate forming step is a step of forming a laminate (containing the first layer) by coating a surface of the thin film with a resin-containing coating liquid.

The resin-containing coating liquid contains at least a resin; and, if necessary, further contains a solvent and other components.

The resin is not particularly limited and may be appropriately selected depending on the purpose. Examples thereof include photocurable resins, thermoplastic resins and thermosetting resins.

The solvent is not particularly limited and may be appropriately selected depending on the purpose. Examples thereof include acetone, methyl ethyl ketone, cyclohexane, xylene and benzene.

The thickness of the coated resin-containing coating liquid after drying is not particularly limited and may be appropriately determined depending on the purpose. It is preferably 3 μm to 30 μm.

When the thickness of the coated resin-containing coating liquid after drying smaller than 3 μm, it may be difficult to form a concavo-convex pattern and a uniform film. Whereas when the thickness thereof is larger than 30 μm, the production efficiency may decrease and the material cost may increase.

The method for coating the surface of the thin film is not particularly limited and may be appropriately selected depending on the purpose. Examples thereof include extrusion coating, bar coating, gravure coating and roll coating.

The method for forming the laminate is not particularly limited and may be appropriately selected depending on the purpose. Examples thereof include UV irradiation and drying.

When the resin-containing coating liquid contains a photocurable resin, the photocurable resin is cured through UV irradiation to form a laminate including the first layer. But, the curing of the photocurable resin does not proceed in the presence of oxygen. Thus, for removing oxygen, nitrogen purging, laminating of the transparent material, etc. are preferably performed. Alternatively, when the coated surface is irradiated with UV rays while being brought into contact with and wound around a roll, oxygen is shielded to attain continuous curing and form a laminated film whose surface is smooth.

When the resin-containing coating liquid contains a solvent, the solvent is evaporated by drying to form the first layer. Here, the coated resin-containing coating liquid is preferably pressure-bonded to a smooth surface before drying so that concave and convex portions do not remain in the surface.

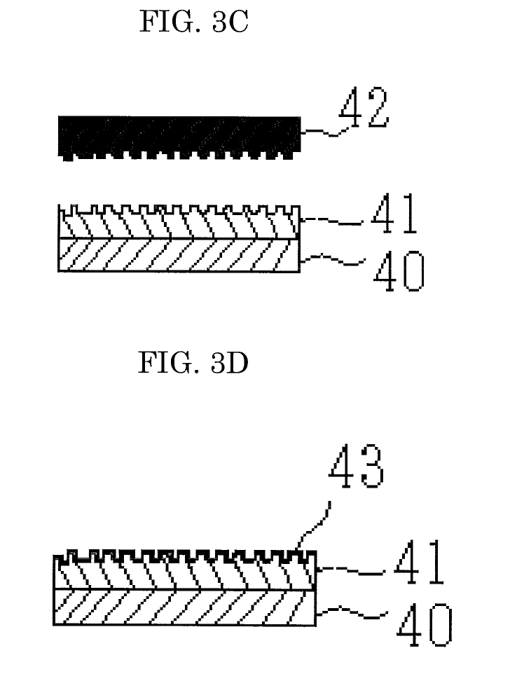

As shown in FIGS. 3A to 3E, in a first embodiment of the method of the present invention for producing an optical sheet, for example, a support film 40 is coated with a light-transmissive curable resin 41 (FIG. 3A); a concavo-convex pattern in a surface of a mold 42 is transferred through irradiation of, for example, UV rays to a surface of the light-transmissive curable resin 41, while the mold 42 is being pressure-bonded to the light-transmissive curable resin 41 (FIG. 3B); the mold 42 is separated from the curable resin 41 (FIG. 3C); a thin film 43 of a reflective material is formed on the curable resin 41 having the concavo-convex pattern in the surface thereof (FIG. 3D); and a resin material 44 is applied on the thin film 43 to form a smooth surface (FIG. 3E).

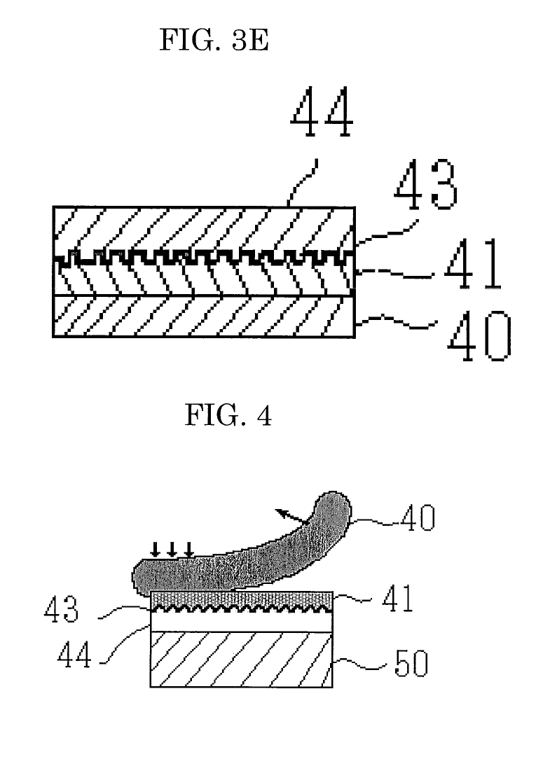

As shown in FIG. 4, the optical sheet produced in this manner is attached to a substrate and then, the support film 40 is peeled off.

In the above method for producing an optical sheet, the curable resin 41 can be replaced with the resin material 44. In this case, when the optical sheet is attached to a substrate 50, the support film 40 is peeled off and the surface from which the support film has been peeled off (the surface being a surface of a film of the resin material 44) is attached to the substrate.

### <<Production by Roll to Roll Production System>>

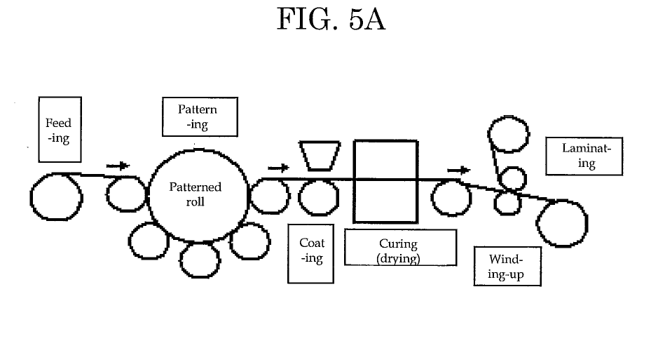

The optical sheet can be efficiently produced using, for example, a Roll to Roll production system as shown in FIG. 5A.

When the Roll to Roll production system is employed in a first embodiment of the method of the present invention for producing an optical sheet, the support film is made in the form of a belt-like film, and the mold is made in the form of a first roll mold having a concavo-convex pattern in its outer circumferential surface. In the above coating step, the belt-like film is continuously coated with a curable resin. In the above second layer-forming step, the belt-like film which has been coated with the curable resin is wound around the first roll mold. In the above laminate forming step, the belt-like film on which a thin film of a reflective material has been formed is wound around a second roll mold having a smooth outer circumferential surface which has been coated with a resin-containing coating liquid.

As shown in FIG. 5B, a method for producing an optical sheet 10 includes a wind-off step of a support film 11F (S10), a second layer-forming step (a second layer-coating step (S20) and a second layer-curing step (S30)), a laminate forming step (a thin film-forming step (unillustrated)), a first layer-forming step (S40) and a first layer-curing step (S50)) and a wind-up step (S60).

In the wind-off step S10, a first support film 11F is wound off from a roll 11R in which the first support film 11F (a long belt-like film) is wound, and is fed to the next step. The thus-fed workpiece (the first support film 11F) is appropriately guided by an unillustrated roller in a travelling direction.

In the second layer-coating step S20, the first support film is coated through extrusion coating with a photocurable resin (a first photocurable resin) whose refractive index has been adjusted high by, for example, a metal oxide. The thickness of the first photocurable resin coated is, for example, 3 μm to 30 μm.

In the second layer-curing step S30, the first support film 11F on which the first photocurable resin layer has been formed is wound around a roll metal mold 31 (a first roll mold) so that the first photocurable resin layer faces the roll metal mold. The first support film 11F wound around the roll metal mold 31 is irradiated from outside with ultraviolet (UV) rays (curing light) using a light source 32. The surface of the roll metal mold 31 is provided in advance with a concavo-convex pattern having a pitch of 100 nm to 5,000 nm. Irradiation of the curing light is performed in a state where the concavo-convex pattern is transferred to the first photocurable resin layer. As a result, the first photocurable resin is cured so as to have the concavo-convex pattern of the roll metal mold 31, whereby a second layer is formed. Notably, in order to cure the first photocurable resin by irradiating it with the curing light from outside of the first support film 11F, the first support film 11F preferably made of a material having a high transmittance with respect to the curing light.

As the workpiece is conveyed, the first support film 11F over which the second layer has been formed is peeled off from the roll metal mold 31.

In a thin film-forming step (not illustrated), a thin film of a reflective material is formed on the surface of the second layer having the concavo-convex pattern.

In the first layer-forming step S40, the surface of the formed thin film is coated through extrusion coating with an acrylic photocurable resin (a second photocurable resin). The thickness of the acrylic photocurable resin coated may be 3 μm to 30 μm similar to the first photocurable resin. Upon coating, air is thought to enter the concavo-convex pattern. But, by adjusting the pitch of the concavo-convex pattern to about a submicron level, the second photocurable resin enters the concave portions of the concavo-convex pattern by virtue of capillary effect, preventing entering of air. Alternatively, the atmosphere in the first layer-forming step S40 may be reduced in pressure to ensure the prevention of entering of air.

The surface of the second photocurable resin coated in the first layer-forming step S40 becomes smooth due to surface tension.

In the first layer-curing step S50, the second photocurable resin is irradiated with ultraviolet (UV) rays (curing light) using a light source 52. As a result, the second photocurable resin is cured to form a first layer. The curing does not proceed in the presence of oxygen. Thus, oxygen is removed by, for example, nitrogen purging. Alternatively, a transparent material the curing light transmits laminated (not illustrated) and then, the curing light is applied through the transparent material.

In the wind-up step S60, a second support film 14 is wound off from a roll 14R and attached to the surface of the first layer. Then, the optical sheet 10 (final product) is wound up by a wind-up apparatus. Notably, the second support film 14 may be optionally provided.

In this manner, the optical sheet 10 can be continuously mass-produced. Notably, when the optical sheet 10 having no support film is produced, a peel-off step of peeling off the first support film 11F from the optical sheet 10 is provided after the first layer-curing step S50 to form the final product from which the first support film 11F has been peeled off.

Also, in order to improve the smoothness of the first layer surface, in the first layer-curing step S50 subsequent to the first layer-forming step S40, the workpiece is wound around a roll metal mold 51 (a second roll mold) having a smooth outer circumferential surface so that a film of a second photocurable resin 13A faces the roll metal mold, and then UV rays are applied to the wound workpiece from the outside thereof using a light source 52 (see FIG. 5C). As a result, the second photocurable resin 13A is cured while being brought into contact with the smooth surface of the roll metal mold 51, making smoother the surface of the first layer 4 formed on the second layer 2. Further, the second photocurable resin 13A is sealed with the roll metal mold 51 and thus, oxygen is shielded to attain curing. Here, the term “smooth” or “smoothness” means that the surface is smoother than the concavo-convex portions of the concavo-convex pattern.

### Second Embodiment

In a second embodiment, a method of the present invention for producing an optical sheet includes at least a first layer-forming step and a second layer-forming step; and, if necessary, further includes an attaching step and other steps.

### <<First Layer-Forming Step>>

The first layer-forming step is a step of forming a first layer by forming a concavo-convex pattern in a light-reflective sheet superposed on and thermally pressure-bonded to a surface of a mold. By pressure-bonding the light-reflective sheet to the surface of the mold, the concavo-convex pattern of the mold is transferred to the light-reflective sheet. Thereafter, the mold is separated from the light-reflective sheet.

The mold is previously described.

The light-reflective sheet is not particularly limited, so long as at least a surface thereof is made of a reflective material, and may be appropriately selected depending on the purpose. Examples thereof include sheets in which a film of a reflective material (e.g., silver and aluminum) is formed on their surfaces through, for example, vapor evaporation and sputtering, and metallic luster sheets (e.g., a metallic luster, and easy-moldable film “PICASUS” (product of TORAY INDUSTRIES, INC.)).

The temperature at which the light-reflective sheet is thermally pressure-bonded to the surface of the mold is not particularly limited and may be appropriately determined depending on the purpose and the properties of the material. It is preferably 100° C. to 300° C.

When the temperature for thermal pressure-bonding is lower than 100° C., it may be difficult to form a concave-convex pattern. When the temperature therefor is higher than 300° C., the material may be considerably deformed.

The pressure at which the light-reflective sheet is thermally pressure-bonded to the surface of the mold is not particularly limited and may be appropriately determined depending on the purpose and the properties of the material. It is preferably 1 MPa to 50 MPa.

When the pressure for thermal pressure-bonding is lower than 1 MPa, it may be difficult to form a concave-convex pattern. When the pressure therefor is higher than 50 MPa, the material may be considerably deformed.

### <<Second Layer-Forming Step>>

The second layer-forming step is a step of forming a second layer by coating a surface of the first layer with a resin-containing coating liquid.

The resin-containing coating liquid contains at least a resin; and, if necessary, further contains a solvent and other components.

The resin is not particularly limited, so long as it can transmit light, and may be appropriately selected depending on the purpose. Examples thereof include acrylic photocurable resins, thermoplastic resins and thermosetting resins.

The solvent is not particularly limited and may be appropriately selected depending on the purpose. Examples thereof include polyhydric alcohols, acetone, methyl ethyl ketone, cyclohexane, xylene and benzene.

The thickness of the coated resin-containing coating liquid is not particularly limited and may be appropriately determined depending on the purpose. It is preferably 3 μm to 30 μm.

When the thickness of the coated resin-containing coating liquid is smaller than 3 μm, it may be difficult to perform coating stably and to maintain the surface smoothness. Whereas when the thickness thereof is larger than 30 μm, productivity may drop and/or the material cost may increase.

The method for coating the resin-containing coating liquid is not particularly limited and may be appropriately selected depending on the purpose. Examples thereof include extrusion coating.

The method for forming the second layer is not particularly limited and may be appropriately selected depending on the purpose. Examples thereof include UV irradiation and drying.

When the resin-containing coating liquid contains a photocurable resin, the photocurable resin is cured through UV irradiation to form a second layer. But, the curing of the photocurable resin does not proceed in the presence of oxygen. Thus, for removing oxygen, nitrogen purging, laminating of the transparent material, etc. are preferably performed. Alternatively, when the coated surface is irradiated with UV rays while being brought into contact with and wound around a roll, oxygen is shielded to attain continuous curing and form a second layer whose surface is smooth.

When the resin-containing coating liquid contains a solvent, the solvent is evaporated by drying to form the second layer. Here, the coated resin-containing coating liquid is preferably pressure-bonded to a smooth surface before drying so that concave and convex portions do not remain in the surface.

### <<Attaching Step>>

The attaching step is a step of attaching a support film on the second layer.

The support film is previously described.

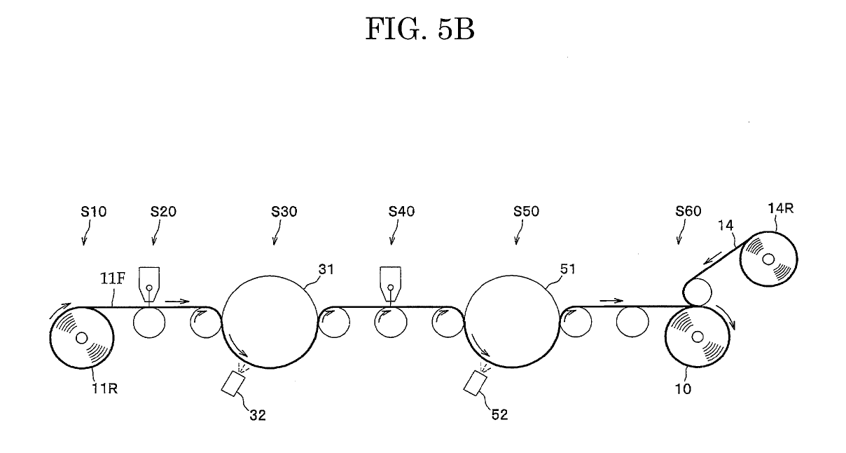

As shown in FIGS. 6A to 6D, in a second embodiment of the method of the present invention for producing an optical sheet, for example, a light-reflective sheet 70 whose surface 70a is made of a reflective material is thermally pressure-bonded to a mold 71 (FIG. 6A); a concavo-convex pattern in a surface of the mold 71 is transferred to the surface 70a of the light-reflective sheet 70, and the mold 71 is separated from the light-reflective sheet 70 (FIG. 6B); a light-transmissive resin material 72, whose refractive index is close to that of the light-emitting layer of the light-emitting element, is applied to the light-reflective sheet 70 having a concavo-convex pattern transferred, to thereby form a smooth surface (FIG. 6C); and a support film 73 is laminated on the resin material 72 (FIG. 6D).

### <<Production by Roll to Roll System>>

When the Roll to Roll production system is employed in a second embodiment of the method of the present invention for producing an optical sheet, the light-reflective sheet is made in the form of a belt-like film, and the mold is made in the form of a first roll mold having a concavo-convex pattern in its outer circumferential surface. In the above first layer-forming step, the belt-like film is wound around the first roll mold and continuously provided with a concavo-convex pattern, to thereby form a first layer. In the second layer-forming step, for example, the belt-like film is wound around a second roll mold having a smooth outer circumferential surface which has been coated with the resin-containing coating liquid, whereby the surface of the first layer is continuously coated with the resin-containing coating liquid.

### Third Embodiment

In a third embodiment, the method of the present invention for producing an optical sheet includes at least a concavo-convex pattern-forming step, a first layer-forming step and a second layer-forming step; and, if necessary, further includes an attaching step and other steps.

### <<Concavo-Convex Pattern-Forming Step>>

The concavo-convex pattern-forming step is a step of forming a concavo-convex pattern in a surface of a support film while a mold having the concavo-convex pattern is being pressure-bonded to the surface thereof. By pressure-bonding the mold to the surface of the support film, the concavo-convex pattern of the mold is transferred to the support film. Then, the mold is separated from the support film. Alternatively, a photocurable resin is applied on a surface of the support film and then, light is applied thereto while the mold is being pressure-bonded, to thereby form a concavo-convex pattern in the surface of the support film.

The mold is previously described.

### <<First Layer-Forming Step>>

The first layer-forming step is a step of forming a first layer by forming a thin film of a reflective material on the concavo-convex pattern. The reflective material is not particularly limited and may be appropriately selected depending on the purpose. Examples thereof include silver, aluminum and nickel.

### <<Second Layer-Forming Step>>

The second layer-forming step is a step of forming a second layer by coating a surface of the first layer with a resin-containing coating liquid.

The resin-containing coating liquid contains at least a resin; and, if necessary, further contains a solvent and other components.

The resin is not particularly limited, so long as it can transmit light, and may be appropriately selected depending on the purpose. Examples thereof include acrylic photocurable resins, thermoplastic resins and thermosetting resins.

The solvent is not particularly limited and may be appropriately selected depending on the purpose. Examples thereof include polyhydric alcohols, acetone, methyl ethyl ketone, cyclohexane, xylene and benzene.

### <<Attaching Step>>

The attaching step is a step of attaching a support film on the second layer.

The support film is previously described.

### <<Production by Roll to Roll System>>

When the Roll to Roll production system is employed in a third embodiment of the method of the present invention for producing an optical sheet, the support film is made in the form of a belt-like film, and the mold is made in the form of a first roll mold having a concavo-convex pattern in its outer circumferential surface. In the above concavo-convex pattern-forming step, the belt-like film is wound around the first roll mold and continuously provided with a concavo-convex pattern. In the first layer-forming step, a thin film of a reflective material is formed on the concavo-convex pattern to form a first layer.

### <Disposition of Optical Sheet>

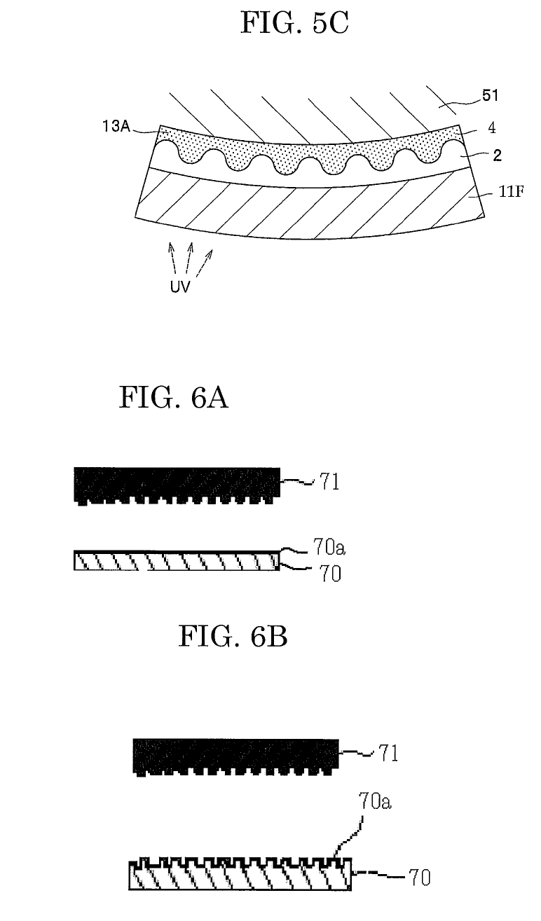

As shown in FIG. 7, the optical sheet 10 is disposed opposite to a light-emitting surface of a light-emitting device 100, from which surface light is emitted from a light-emitting element 11. When the light-emitting device 100 has a top-emission structure, the optical sheet 10 is disposed between a light-emitting element 11 and a substrate 12. In this structure, a second layer 10a of the optical sheet 10 is located at the light-emitting side (at the side of the light-emitting element 11), and a first layer 10b of the optical sheet 10 is located at the side opposite to the light-emitting side (at the side of the substrate 12).

### <<Light-Emitting Element>>

The light-emitting element is not particularly limited and may be appropriately selected depending on the purpose. Examples thereof include an organic EL element, an inorganic EL element, an LED and a photodiode.

The organic EL element will next be described in detail.

### <<<Organic EL Element>>>

The organic EL element includes a cathode, an anode and organic compound layers including an organic light-emitting layer, the organic light-emitting layers being sandwiched between the cathode and the anode. In terms of the function of a light-emitting element, at least one of the anode and the cathode is preferably transparent.

As a lamination pattern of the organic compound layers, preferably, a hole-transport layer, an organic light-emitting layer and an electron transport layer are laminated in this order from the anode side. Moreover, a hole-injection layer is provided between the hole-transport layer and the cathode, and/or an electron-transportable intermediate layer is provided between the organic light-emitting layer and the electron transport layer. Also, a hole-transportable intermediate layer may be provided between the organic light-emitting layer and the hole-transport layer. Similarly, an electron-injection layer may be provided between the cathode and the electron-transport layer.

Notably, each layer may be composed of a plurality of secondary layers.

The organic light-emitting layer corresponds to a light-emitting layer. Also, a transparent layer(s) of the anode, cathode, and organic compound layers (i.e., a layer(s) having optical transparency) correspond(s) to a light-transmitting layer.

Each of the constituent layers of the organic compound layers can be suitably formed in accordance with any of a dry film-forming method (e.g., a vapor deposition method and a sputtering method); a transfer method; a printing method; an ink-jet method; and a spray method.

### <<<<Anode>>>>

In general, the anode may be any material, so long as it has the function of serving as an electrode which supplies holes to the organic compound layers. The shape, structure, size, etc. thereof are not particularly limited and may be appropriately selected from known electrode materials depending on the application/purpose of the light-emitting element. As described above, the anode is generally provided as a transparent anode.

Preferred examples of the materials for the anode include metals, alloys, metal oxides, conductive compounds and mixtures thereof. Specific examples include conductive metal oxides such as tin oxides doped with, for example, antimony and fluorine (ATO and FTO); tin oxide, zinc oxide, indium oxide, indium tin oxide (ITO) and indium zinc oxide (IZO); metals such as gold, silver, chromium and nickel; mixtures or laminates of these metals and the conductive metal oxides; inorganic conductive materials such as copper iodide and copper sulfide; organic conductive materials such as polyaniline, polythiophene and polypyrrole; and laminates of these materials and ITO. Among them, conductive metal oxides are preferred. In particular, ITO is preferred from the viewpoints of productivity, high conductivity, transparency, etc.

The anode may be formed on the substrate by a method which is appropriately selected from wet methods such as printing methods and coating methods; physical methods such as vacuum deposition methods, sputtering methods and ion plating method; and chemical methods such as CVD and plasma CVD methods, in consideration of suitability for the material for the anode. For example, when ITO is used as a material for the anode, the anode may be formed in accordance with a DC or high-frequency sputtering method, a vacuum deposition method, or an ion plating method.

In the organic EL layer, a position at which the anode is to be formed is not particularly limited and may be appropriately determined depending on the application/purpose of the light-emitting element.

Patterning for forming the anode may be performed by a chemical etching method such as photolithography; a physical etching method such as etching by laser; a method of vacuum deposition or sputtering using a mask; a lift-off method; or a printing method.

The thickness of the anode may be appropriately selected depending on the material for the anode and is, therefore, not definitely determined. It is generally about 10 nm to about 50 μm, preferably 50 nm to 20 μm.

The resistance of the anode is preferably 10³ Ω/spuare or less, more preferably 10² Ω/spuare or less. When the anode is transparent, it may be colorless or colored. For extracting luminescence from the transparent anode side, it is preferred that the anode has a light transmittance of 60% or higher, more preferably 70% or higher.

Concerning transparent anodes, there is a detail description in “TOUMEI DOUDEN-MAKU NO SHINTENKAI (Novel Developments in Transparent Electrode Films)” edited by Yutaka Sawada, published by C.M.C. in 1999, the contents of which can be applied to the present invention. When a plastic substrate having a low heat resistance is used, it is preferred that ITO or IZO is used to form a transparent anode at a low temperature of 150° C. or lower.

### <<<<Cathode>>>>

In general, the cathode may be any material so long as it has the function of serving as an electrode which injects electrons into the organic compound layers. The shape, structure, size, etc. thereof are not particularly limited and may be appropriately selected from known electrode materials depending on the application/purpose of the light-emitting element.

Examples of the materials for the cathode include metals, alloys, metal oxides, conductive compounds and mixtures thereof. Specific examples thereof include alkali metals (e.g., Li, Na, K and Cs), alkaline earth metals (e.g., Mg and Ca), gold, silver, lead, aluminum, sodium-potassium alloys, lithium-aluminum alloys, magnesium-silver alloys and rare earth metals (e.g., indium and ytterbium). These may be used individually, but it is preferred that two or more of them are used in combination from the viewpoint of satisfying both stability and electron-injection property.

Among them, as the materials for forming the cathode, alkali metals or alkaline earth metals are preferred in terms of excellent electron-injection property, and materials containing aluminum as a major component are preferred in terms of excellent storage stability.

The term “material containing aluminum as a major component” refers to a material composed of aluminum alone; alloys containing aluminum and 0.01% by mass to 10% by mass of an alkali or alkaline earth metal; or the mixtures thereof (e.g., lithium-aluminum alloys and magnesium-aluminum alloys).

The materials for the cathode are described in detail in JP-A Nos. 02-15595 and 05-121172. The materials described in these literatures can be used in the present invention.

The method for forming the cathode is not particularly limited, and the cathode may be formed by a known method. For example, the cathode may be formed by a method which is appropriately selected from wet methods such as printing methods and coating methods; physical methods such as vacuum deposition methods, sputtering methods and ion plating methods; and chemical methods such as CVD and plasma CVD methods, in consideration of suitability for the material for the cathode. For example, when a metal (or metals) is (are) selected as a material (or materials) for the cathode, one or more of them may be applied simultaneously or sequentially by a sputtering method.

Patterning for forming the cathode may be performed by a chemical etching method such as photolithography; a physical etching method such as etching by laser; a method of vacuum deposition or sputtering using a mask; a lift-off method; or a printing method.

In the organic EL layer, a position at which the cathode is to be formed is not particularly limited, and the cathode may be entirely or partially formed on the organic compound layer.

Furthermore, a dielectric layer having a thickness of 0.1 nm to 5 nm and being made, for example, of fluorides and oxides of an alkali or alkaline earth metal may be inserted between the cathode and the organic compound layer. The dielectric layer may be considered to be a kind of electron-injection layer. The dielectric layer may be formed by, for example, a vacuum deposition method, a sputtering method and an ion plating method.

The thickness of the cathode may be appropriately selected depending on the material for the cathode and is, therefore, not definitely determined. It is generally about 10 nm to about 5 μm, and preferably 50 nm to 1 μm.

Moreover, the cathode may be transparent or opaque. The transparent cathode may be formed as follows. Specifically, a 1 nm- to 10 nm-thick thin film is formed from a material for the cathode, and a transparent conductive material (e.g., ITO and IZO) is laminated on the thus-formed film.

### <<<<Organic Compound Layer>>>>

The organic EL element includes at least one organic compound layer including an organic light-emitting layer. Examples of the other organic compound layers than the organic light-emitting layer include a hole-transport layer, an electron-transport layer, a hole-blocking layer, an electron-blocking layer, a hole-injection layer and an electron-injection layer.

In the organic EL element, the respective layers constituting the organic compound layers can be suitably formed by any of a dry film-forming method such as a vapor deposition method and a sputtering method; a wet film-forming method; a transfer method; a printing method; and an ink-jet method.

### <<<<<Organic Light-Emitting Layer>>>>>

The organic light-emitting layer is a layer having the functions of receiving holes from the anode, the hole-injection layer, or the hole-transport layer, and receiving electrons from the cathode, the electron-injection layer, or the electron transport layer, and providing a field for recombination of the holes with the electrons for light emission, when an electric field is applied.

The organic light-emitting layer may be composed only of a light-emitting material, or may be a layer formed form a mixture of a light-emitting dopant and a host material. The light-emitting dopant may be a fluorescent or phosphorescent light-emitting material, and two or more of the light-emitting dopant may be used. The host material is preferably a charge-transporting material. Also, one or more of the host material may be used, and the host material, for example, is a mixture of a hole-transporting host material and an electron-transporting host material. Further, a material which does not emit light nor transport any charge may be contained in the organic light-emitting layer.

The organic light-emitting layer may be a single layer or two or more layers. When it is two or more layers, the layers may emit lights of different colors.

The above light-emitting dopant may be, for example, a phosphorescent light-emitting material (phosphorescent light-emitting dopant) and a fluorescent light-emitting material (fluorescent light-emitting dopant).

The organic light-emitting layer may contain two or more different light-emitting dopants for improving color purity and/or expanding the wavelength region of light emitted therefrom. From the viewpoint of drive durability, it is preferred that the light-emitting dopant is those satisfying the following relation(s) with respect to the above-described host compound: i.e., 1.2 eV>difference in ionization potential (ΔIp)>0.2 eV and/or 1.2 eV>difference in electron affinity (ΔEa)>0.2 eV.

The phosphorescent light-emitting dopant is not particularly limited and may be appropriately selected depending on the purpose. Examples thereof include complexes containing a transition metal atom or a lanthanoid atom.

The transition metal atom is not particularly limited and may be selected depending on the purpose. Preferred are ruthenium, rhodium, palladium, tungsten, rhenium, osmium, iridium gold, silver, copper and platinum. More preferred are rhenium, iridium and platinum. Particularly preferred are iridium and platinum.

The lanthanoid atom is not particularly limited and may be appropriately selected depending on the purpose. Examples thereof include lanthanum, cerium, praseodymium, neodymium, samarium, europium, gadolinium, terbium, dysprosium, holmium, erbium, thulium, ytterbium and lutetium, with neodymium, europium and gadolinium being preferred.

Examples of ligands in the complex include those described in, for example, “Comprehensive Coordination Chemistry” authored by G. Wilkinson et al., published by Pergamon Press Company in 1987; “Photochemistry and Photophysics of Coordination Compounds” authored by H. Yersin, published by Springer-Verlag Company in 1987; and “YUHKI KINZOKU KAGAKU—KISO TO OUYOU—(Metalorganic Chemistry—Fundamental and Application—)” authored by Akio Yamamoto, published by Shokabo Publishing Co., Ltd. in 1982.

Preferred examples of the ligands include halogen ligands (preferably, chlorine ligand), aromatic carbon ring ligands (preferably 5 to 30 carbon atoms, more preferably 6 to 30 carbon atoms, still more preferably 6 to 20 carbon atoms, particularly preferably 6 to 12 carbon atoms, such as cyclopentadienyl anion, benzene anion and naphthyl anion); nitrogen-containing hetero cyclic ligands (preferably 5 to 30 atoms, more preferably 6 to 30 carbon atoms, still more preferably 6 to 20 carbon atoms, particularly preferably 6 to 12 carbon atoms, such as phenyl pyridine, benzoquinoline, quinolinol, bipyridyl and phenanthrorine), diketone ligands (e.g., acetyl acetone), carboxylic acid ligands (preferably 2 to 30 carbon atoms, more preferably 2 to 20 carbon atoms, still more preferably 2 to 16 carbon atoms, such as acetic acid ligand), alcoholate ligands (preferably 1 to 30 carbon atoms, more preferably 1 to 20 carbon atoms, still more preferably 6 to 20 carbon atoms, such as phenolate ligand), silyloxy ligands (preferably 3 to 40 carbon atoms, more preferably 3 to 30 carbon atoms, particularly preferably 3 to 20 carbon atoms, such as trimethyl silyloxy ligand, dimethyl tert-butyl silyloxy ligand and triphenyl silyloxy ligand), carbon monoxide ligand, isonitrile ligand, cyano ligand, phosphorus ligand (preferably 3 to 40 carbon atoms, more preferably 3 to 30 carbon atoms, still more preferably 3 to 20 carbon atoms, particularly preferably, 6 to 20 carbon atoms, such as triphenyl phosphine ligand), thiolate ligands (preferably 1 to 30 carbon atoms, more preferably 1 to 20 carbon atoms, still more preferably 6 to 20 carbon atoms, such as phenyl thiolate ligand) and phosphine oxide ligands (preferably 3 to 30 carbon atoms, more preferably 8 to 30 carbon atoms, particularly preferably 18 to 30 carbon atoms, such as triphenyl phosphine oxide ligand), with nitrogen-containing hetero cyclic ligand being more preferred.

The above-described complexes may be a complex containing one transition metal atom in the compound, or a so-called polynuclear complex containing two or more transition metal atoms. In the latter case, the complexes may contain different metal atoms at the same time.

Among them, specific examples of the light-emitting dopants include phosphorescent light-emitting compounds described in Patent Literatures such as U.S. Pat. No. 6,303,238B1, U.S. Pat. No. 6,097,147, WO00/57676, WO00/70655, WO01/08230, WO01/39234A2, WO01/41512A1, WO02/02714A2, WO02/15645A1, WO02/44189A1, WO05/19373A2, JP-A Nos. 2001-247859, 2002-302671, 2002-117978, 2003-133074, 2002-235076, 2003-123982 and 2002-170684, EP1211257, JP-A Nos. 2002-226495, 2002-234894, 2001-247859, 2001-298470, 2002-173674, 2002-203678, 2002-203679, 2004-357791, 2006-256999, 2007-19462, 2007-84635 and 2007-96259. Among them, Ir complexes, Pt complexes, Cu complexes, Re complexes, W complexes, Rh complexes, Ru complexes, Pd complexes, Os complexes, Eu complexes, Tb complexes, Gd complexes, Dy complexes and Ce complexes are preferred, with Ir complexes, Pt complexes and Re complexes being more preferred. Among them, Ir complexes, Pt complexes, and Re complexes each containing at least one coordination mode of metal-carbon bonds, metal-nitrogen bonds, metal-oxygen bonds and metal-sulfur bonds are still more preferred. Furthermore, Ir complexes, Pt complexes, and Re complexes each containing a tri-dentate or higher poly-dentate ligand are particularly preferred from the viewpoints of, for example, light-emission efficiency, drive durability and color purity. For example, tris(2-phenylpyridine)iridium (Ir(ppy)₃) can be used.

The fluorescent light-emitting dopant is not particularly limited and may be appropriately selected depending on the purpose. Examples thereof include benzoxazole, benzoimidazole, benzothiazole, styrylbenzene, polyphenyl, diphenylbutadiene, tetraphenylbutadiene, naphthalimide, coumarin, pyran, perinone, oxadiazole, aldazine, pyralidine, cyclopentadiene, bis-styrylanthracene, quinacridone, pyrrolopyridine, thiadiazolopyridine, cyclopentadiene, styrylamine, aromatic dimethylidene compounds, condensed polyaromatic compounds (e.g., anthracene, phenanthroline, pyrene, perylene, rubrene and pentacene), various metal complexes (e.g., metal complexes of 8-quinolynol, pyromethene complexes and rare-earth complexes), polymer compounds (e.g., polythiophene, polyphenylene and polyphenylenevinylene), organic silanes and derivatives thereof.

Non-limitative specific examples of the light-emitting dop ants include the following compounds.

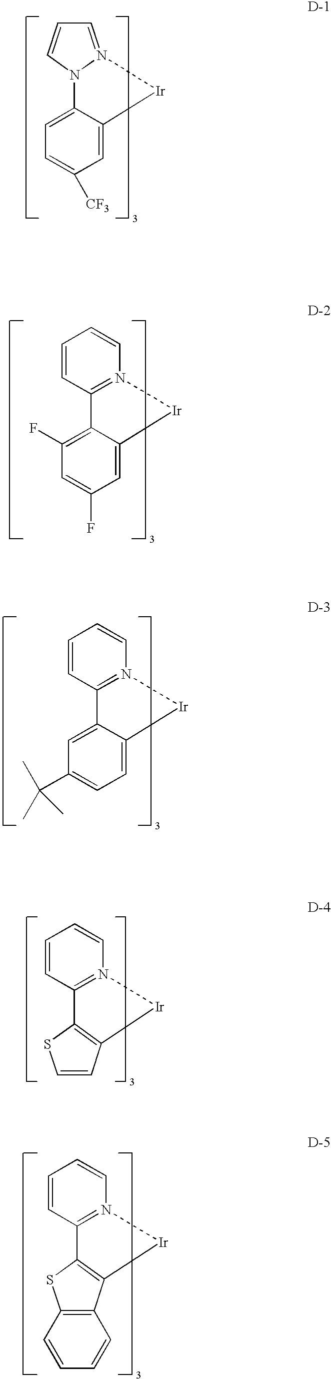

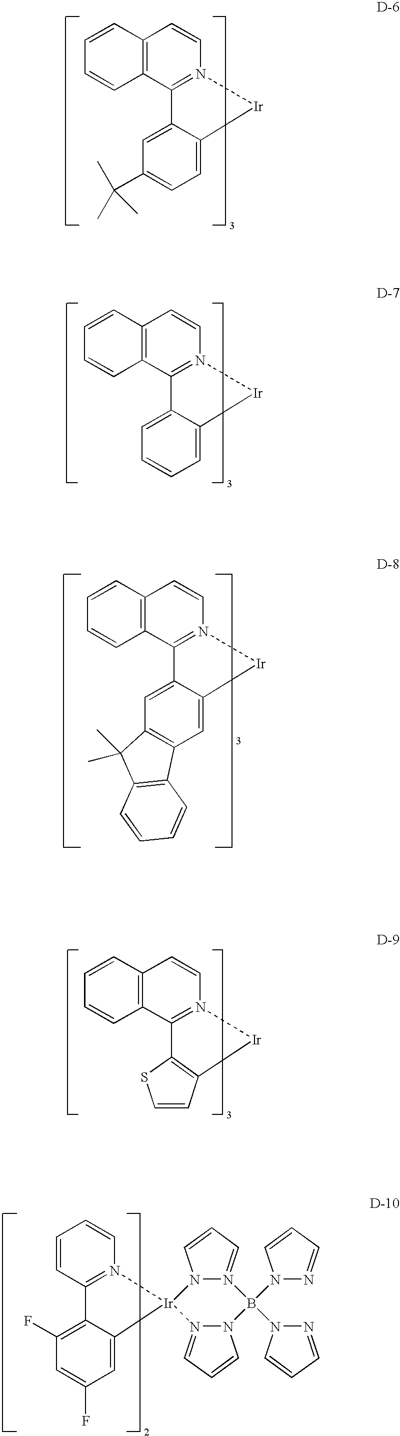

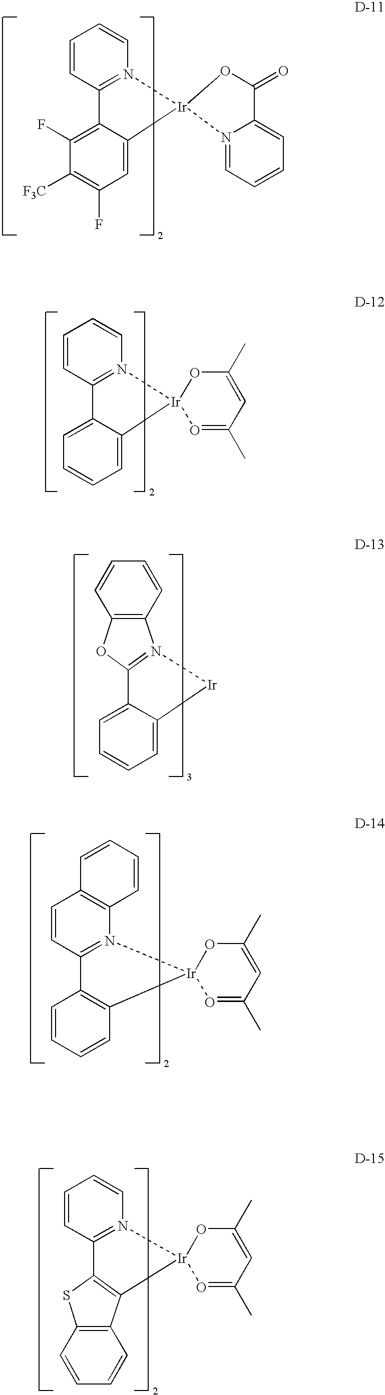

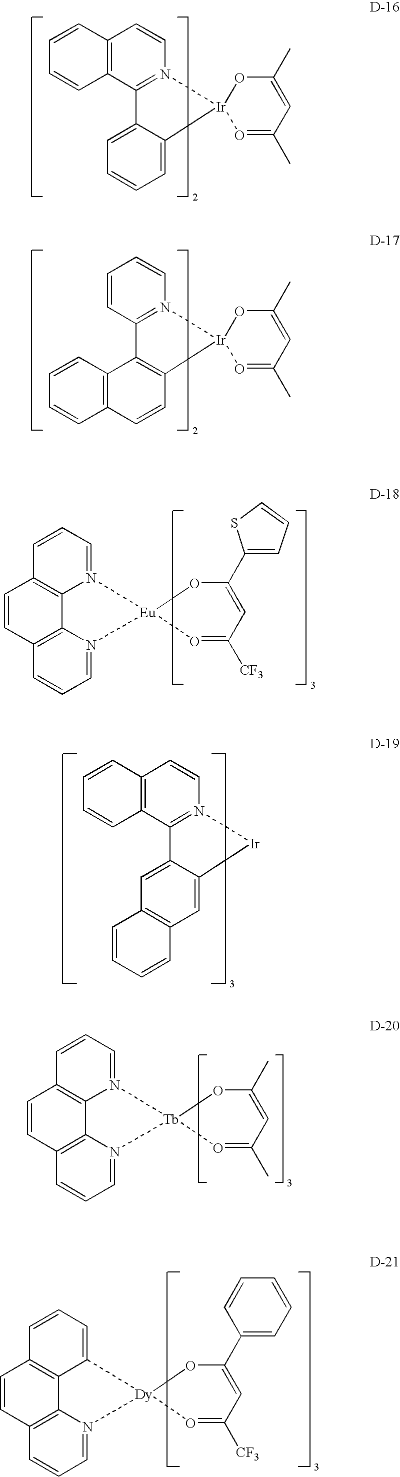

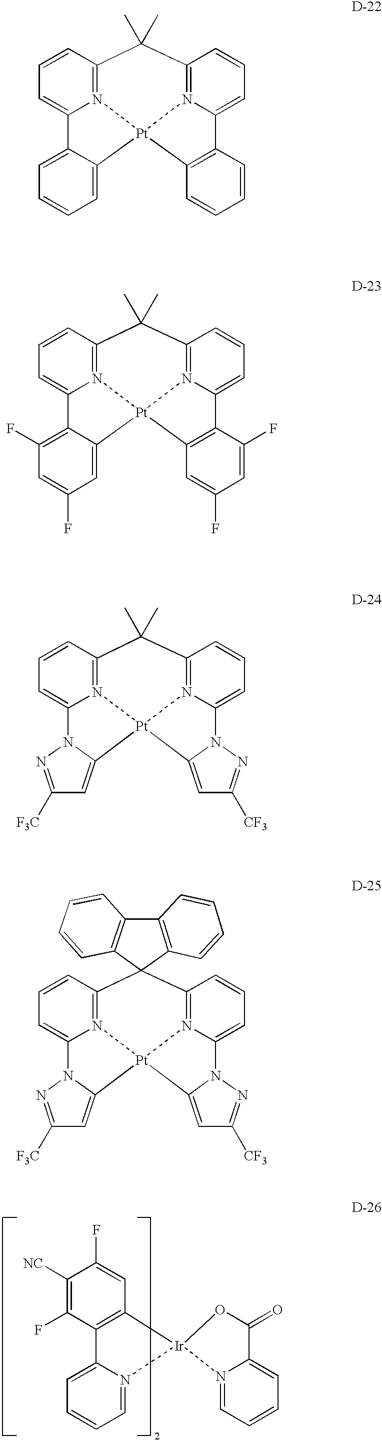

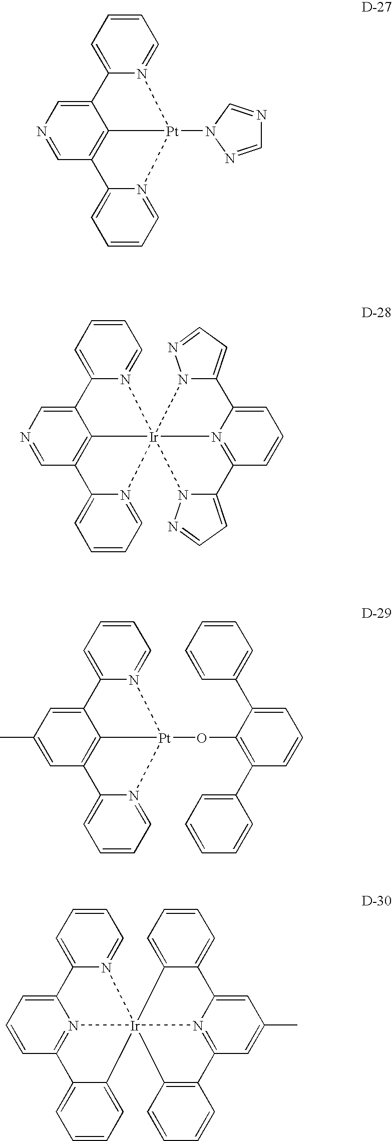

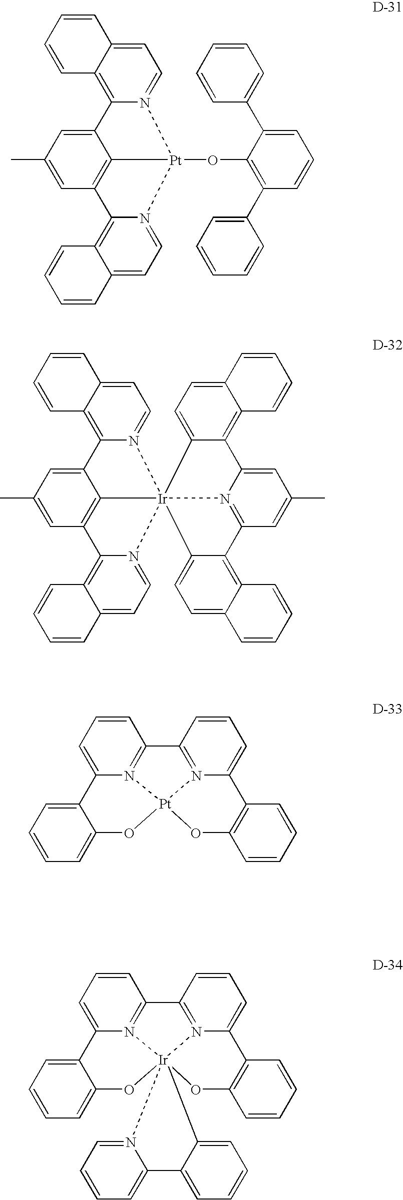

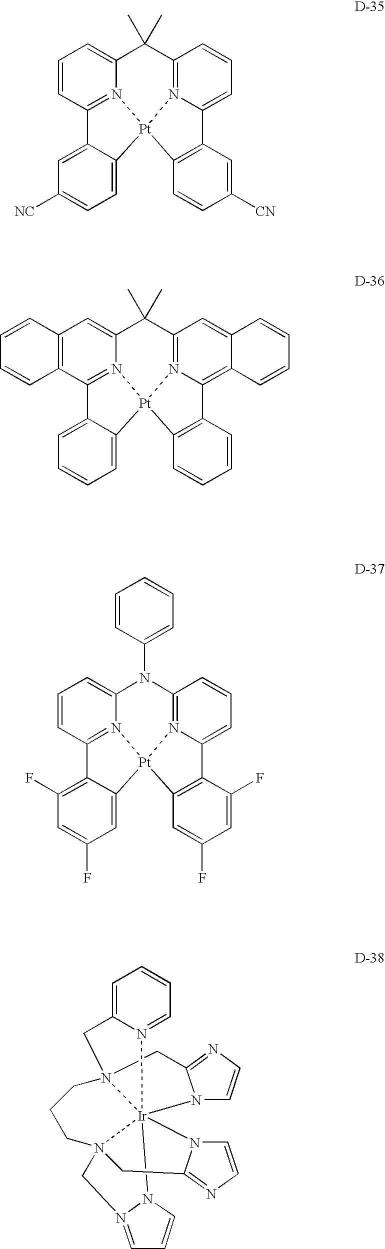

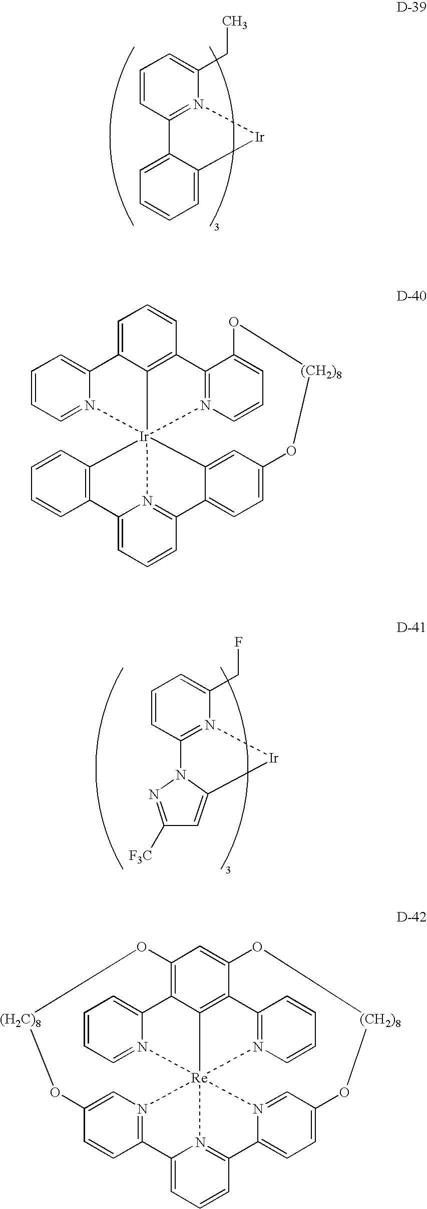

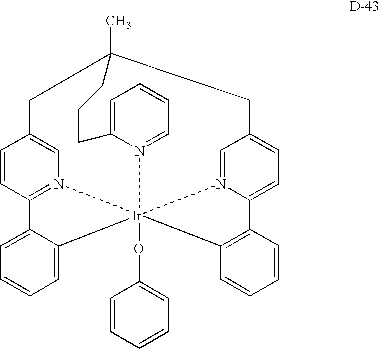

The light-emitting dopant is contained in the organic light-emitting layer in an amount of 0.1% by mass to 50% by mass with respect to the total amount of the compounds generally forming the organic light-emitting layer. From the viewpoints of durability and external quantum efficiency, it is preferably contained in an amount of 1% by mass to 50% by mass, more preferably 2% by mass to 40% by mass.

Although the thickness of the organic light-emitting layer is not particularly limited, in general, it is preferably 2 nm to 500 nm. From the viewpoint of external quantum efficiency, it is more preferably 3 nm to 200 nm, particularly preferably 5 nm to 100 nm.

The host material may be hole transporting host materials excellent in hole transporting property (which may be referred to as a “hole transporting host”) or electron transporting host compounds excellent in electron transporting property (which may be referred to as an “electron transporting host”).

Examples of the hole transporting host materials contained in the organic light-emitting layer include pyrrole, indole, carbazole, azaindole, azacarbazole, triazole, oxazole, oxadiazole, pyrazole, imidazole, thiophene, polyarylalkane, pyrazoline, pyrazolone, phenylenediamine, arylamine, amino-substituted chalcone, styrylanthracene, fluorenone, hydrazone, stilbene, silazane, aromatic tertiary amine compounds, styrylamine compounds, aromatic dimethylidine compounds, porphyrin compounds, polysilane compounds, poly(N-vinylcarbazole), aniline copolymers, conductive high-molecular-weight oligomers (e.g., thiophene oligomers and polythiophenes), organic silanes, carbon films and derivatives thereof. For example, 1,3-bis(carbazol-9-yl) benzene (mCP) can be used.

Among them, indole derivatives, carbazole derivatives, aromatic tertiary amine compounds and thiophene derivatives are preferred. Also, compounds each containing a carbazole group in the molecule are more preferred. Further, compounds each containing a t-butyl-substituted carbazole group are particularly preferred.

The electron transporting host to be used in the organic light-emitting layer preferably has an electron affinity Ea of 2.5 eV to 3.5 eV, more preferably 2.6 eV to 3.4 eV, particularly preferably 2.8 eV to 3.3 eV, from the viewpoints of improvement in durability and decrease in drive voltage. Also, it preferably has an ionization potential Ip of 5.7 eV to 7.5 eV, more preferably 5.8 eV to 7.0 eV, particularly preferably 5.9 eV to 6.5 eV, from the viewpoints of improvement in durability and decrease in drive voltage.

Examples of the electron transporting host include pyridine, pyrimidine, triazine, imidazole, pyrazole, triazole, oxazole, oxadiazole, fluorenone, anthraquinonedimethane, anthrone, diphenylquinone, thiopyrandioxide, carbodiimide, fluorenylidenemethane, distyrylpyradine, fluorine-substituted aromatic compounds, heterocyclic tetracarboxylic anhydrides (e.g., naphthalene and perylene), phthalocyanine, derivatives thereof (which may form a condensed ring with another ring) and various metal complexes such as metal complexes of 8-quinolynol derivatives, metal phthalocyanine, and metal complexes having benzoxazole or benzothiazole as a ligand.

Preferred electron transporting hosts are metal complexes, azole derivatives (e.g., benzimidazole derivatives and imidazopyridine derivatives) and azine derivatives (e.g., pyridine derivatives, pyrimidine derivatives and triazine derivatives). Among them, metal complexes are preferred in terms of durability. As the metal complexes (A), preferred are those containing a ligand which has at least one nitrogen atom, oxygen atom, or sulfur atom and which coordinates with the metal.

The metal ion contained in the metal complex is not particularly limited and may be appropriately selected depending on the purpose. It is preferably a beryllium ion, a magnesium ion, an aluminum ion, a gallium ion, a zinc ion, an indium ion, a tin ion, a platinum ion or a palladium ion; more preferably is a beryllium ion, an aluminum ion, a gallium ion, a zinc ion, a platinum ion or a palladium ion; particularly preferably is an aluminum ion, a zinc ion or a palladium ion.

Although there are a variety of known ligands to be contained in the metal complexes, examples thereof include those described in, for example, “Photochemistry and Photophysics of Coordination Compounds” authored by H. Yersin, published by Springer-Verlag Company in 1987; and “YUHKI KINZOKU KAGAKU—KISO TO OUYOU—(Metalorganic Chemistry—Fundamental and Application—)” authored by Akio Yamamoto, published by Shokabo Publishing Co., Ltd. in 1982.

The ligand is preferably nitrogen-containing heterocyclic ligands (preferably having 1 to 30 carbon atoms, more preferably 2 to 20 carbon atoms, particularly preferably 3 to 15 carbon atoms). It may be a unidentate ligand or a bi- or higher-dentate ligand. Preferred are bi- to hexa-dentate ligands, and mixed ligands of bi- to hexa-dentate ligands with a unidentate ligand.

Examples of the ligand include azine ligands (e.g., pyridine ligands, bipyridyl ligands and terpyridine ligands); hydroxyphenylazole ligands (e.g., hydroxyphenylbenzoimidazole ligands, hydroxyphenylbenzoxazole ligands, hydroxyphenylimidazole ligands and hydroxyphenylimidazopyridine ligands); alkoxy ligands (those having preferably 1 to 30 carbon atoms, more preferably 1 to 20 carbon atoms, particularly preferably 1 to 10 carbon atoms, such as methoxy, ethoxy, butoxy and 2-ethylhexyloxy); and aryloxy ligands (those having preferably 6 to 30 carbon atoms, more preferably 6 to 20 carbon atoms, particularly preferably 6 to 12 carbon atoms, such as phenyloxy, 1-naphthyloxy, 2-naphthyloxy, 2,4,6-trimethylphenyloxy and 4-biphenyloxy).

Further examples include heteroaryloxy ligands (those having preferably 1 to 30 carbon atoms, more preferably 1 to 20 carbon atoms, particularly preferably 1 to 12 carbon atoms, examples of which include pyridyloxy, pyrazyloxy, pyrimidyloxy and quinolyloxy); alkylthio ligands (those having preferably 1 to 30 carbon atoms, more preferably 1 to 20 carbon atoms, particularly preferably 1 to 12 carbon atoms, examples of which include methylthio and ethylthio); arylthio ligands (those having preferably 6 to 30 carbon atoms, more preferably 6 to 20 carbon atoms, particularly preferably 6 to 12 carbon atoms, examples of which include phenylthio);heteroarylthio ligands (those having preferably 1 to 30 carbon atoms, more preferably 1 to 20 carbon atoms, particularly preferably 1 to 12 carbon atoms, examples of which include pyridylthio, 2-benzimidazolylthio, 2-benzoxazolylthio and 2-benzothiazolylthio); siloxy ligands (those having preferably 1 to 30 carbon atoms, more preferably 3 to 25 carbon atoms, particularly preferably 6 to 20 carbon atoms, examples of which include a triphenylsiloxy group, a triethoxysiloxy group and a triisopropylsiloxy group); aromatic hydrocarbon anion ligands (those having preferably 6 to 30 carbon atoms, more preferably 6 to 25 carbon atoms, particularly preferably 6 to 20 carbon atoms, examples of which include a phenyl anion, a naphthyl anion and an anthranyl anion); aromatic heterocyclic anion ligands (those having preferably 1 to 30 carbon atoms, more preferably 2 to 25 carbon atoms, and particularly preferably 2 to 20 carbon atoms, examples of which include a pyrrole anion, a pyrazole anion, a triazole anion, an oxazole anion, a benzoxazole anion, a thiazole anion, a benzothiazole anion, a thiophene anion and a benzothiophene anion); and indolenine anion ligands. Among them, nitrogen-containing heterocyclic ligands, aryloxy ligands, heteroaryloxy groups, siloxy ligands, etc. are preferred, and nitrogen-containing heterocyclic ligands, aryloxy ligands, siloxy ligands, aromatic hydrocarbon anion ligands, aromatic heterocyclic anion ligands, etc. are more preferred.

Examples of the metal complex electron transporting host include compounds described in, for example, JP-A Nos. 2002-235076, 2004-214179, 2004-221062, 2004-221065, 2004-221068 and 2004-327313.

In the organic light-emitting layer, it is preferred that the lowest triplet excitation energy (T1) of the host material is higher than T1 of the phosphorescent light-emitting material, from the viewpoints of color purity, light-emitting efficiency and drive durability.

Although the amount of the host compound added is not particularly limited, it is preferably 15% by mass to 95% by mass with respect to the total amount of the compounds forming the light-emitting layer, in terms of light emitting efficiency and drive voltage.

### <<<<<Hole-Injection Layer and Hole-Transport Layer>>>>>

The hole-injection layer and hole-transport layer are layers having the function of receiving holes from the anode or from the anode side and transporting the holes to the cathode side. Materials to be incorporated into the hole-injection layer or the hole-transport layer may be a low-molecular-weight compound or a high-molecular-weight compound.

Specifically, these layers preferably contain, for example, pyrrole derivatives, carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidine compounds, phthalocyanine compounds, porphyrin compounds, thiophene derivatives, organosilane derivatives and carbon.

Also, an electron-accepting dopant may be incorporated into the hole-injection layer or the hole-transport layer of the organic EL element. The electron-accepting dopant may be, for example, an inorganic or organic compound, so long as it has electron accepting property and the function of oxidizing an organic compound.

Specific examples of the inorganic compound include metal halides (e.g., ferric chloride, aluminum chloride, gallium chloride, indium chloride and antimony pentachloride) and metal oxides (e.g., vanadium pentaoxide and molybdenum trioxide).

As the organic compounds, those having a substituent such as a nitro group, a halogen atom, a cyano group and a trifluoromethyl group; quinone compounds; acid anhydride compounds; and fullerenes may be preferably used.

In addition, there can be preferably used compounds described in, for example, JP-A Nos. 06-212153, 11-111463, 11-251067, 2000-196140, 2000-286054, 2000-315580, 2001-102175, 2001-160493, 2002-252085, 2002-56985, 2003-157981, 2003-217862, 2003-229278, 2004-342614, 2005-72012, 2005-166637 and 2005-209643.

Among them, preferred are hexacyanobutadiene, hexacyanobenzene, tetracyanoethylene, tetracyanoquinodimethane, tetrafluorotetracyanoquinodimethane (F4-TCNQ), p-fluoranil, p-chloranil, p-bromanil, p-benzoquinone, 2,6-dichlorobenzoquinone, 2,5-dichlorobenzoquinone, 1,2,4,5-tetracyanobenzene, 1,4-dicyanotetrafluorobenzene, 2,3-dichloro-5,6-dicyanobenzoquinone, p-dinitrobenzene, m-dinitrobenzene, o-dinitrobenzene, 1,4-naphthoquinone, 2,3-dichloronaphthoquinone, 1,3-dinitronaphthalene, 1,5-dinitronaphthalene, 9,10-anthraquinone, 1,3,6,8-tetranitrocarbazole, 2,4,7-trinitro-9-fluorenone, 2,3,5,6-tetracyanopyridine and fullerene C₆₀. More preferred are hexacyanobutadiene, hexacyanobenzene, tetracyanoethylene, tetracyanoquinodimethane, tetrafluorotetracyanoquinodimethane, p-fluoranil, p-chloranil, p-bromanil, 2,6-dichlorobenzoquinone, 2,5-dichlorobenzoquinone, 2,3-dichloronaphthoquinone, 1,2,4,5-tetracyanobenzene, 2,3-dichloro-5,6-dicyanobenzoquinone, 4,4′,4″-tris(2-naphthylphenylamino)triphenylamine (2-TNATA), N,N′-dinaphthyl-N,N′-diphenyl-[1,1′-biphenyl]-4,4′-diamine (α-NPD) and 2,3,5,6-tetracyanopyridine. Particularly preferred is tetrafluorotetracyanoquinodimethane.

These electron-accepting dopants may be used alone or in combination. Although the amount of the electron-accepting dopant used depends on the type of material, the dopant is preferably used in an amount of 0.01% by mass to 50% by mass, more preferably 0.05% by mass to 20% by mass, particularly preferably 0.1% by mass to 10% by mass, with respect to the material of the hole-transport layer.

The thicknesses of the hole-injection layer and the hole-transport layer are each preferably 500 nm or less in terms of reducing drive voltage.

The thickness of the hole-transport layer is preferably 1 nm to 500 nm, more preferably 5 nm to 200 nm, still more preferably 10 nm to 100 nm. The thickness of the hole-injection layer is preferably 0.1 nm to 200 nm, more preferably 0.5 nm to 100 nm, still more preferably 1 nm to 100 nm.

Each of the hole-injection layer and the hole-transport layer may have a single-layered structure made of one or more of the above-mentioned materials, or a multi-layered structure made of a plurality of layers which are identical or different in composition.

### <<<<<Electron-Injection Layer and Electron-Transport Layer>>>>>

The electron-injection layer and the electron-transport layer are layers having the functions of receiving electrons from the cathode or the cathode side and transporting the electrons to the anode side. The electron-injection materials or electron-transport materials for these layers may be low-molecular-weight or high-molecular-weight compounds.

Specific examples thereof include pyridine derivatives, quinoline derivatives, pyrimidine derivatives, pyrazine derivatives, phthalazine derivatives, phenanthoroline derivatives, triazine derivatives, triazole derivatives, oxazole derivatives, oxadiazole derivatives, imidazole derivatives, fluorenone derivatives, anthraquinodimethane derivatives, anthrone derivatives, diphenylquinone derivatives, thiopyrandioxide derivatives, carbodiimide derivatives, fluorenylidenemethane derivatives, distyrylpyradine derivatives, aryl tetracarboxylic anhydrides such as perylene and naphthalene, phthalocyanine derivatives, metal complexes (e.g., metal complexes of 8-quinolinol derivatives, metal phthalocyanine, and metal complexes containing benzoxazole or benzothiazole as the ligand) and organic silane derivatives (e.g., silole).

The electron-injection layer or the electron-transport layer in the organic EL element of the present invention may contain an electron donating dopant. The electron donating dopant to be introduced in the electron-injection layer or the electron-transport layer may be any material, so long as it has an electron-donating property and a property for reducing an organic compound. Preferred examples thereof include alkali metals (e.g., Li), alkaline earth metals (e.g., Mg), transition metals including rare-earth metals, and reducing organic compounds. Among the metals, those having a work function of 4.2 eV or less are particularly preferably used. Examples thereof include Li, Na, K, Be, Mg, Ca, Sr, Ba, Y, Cs, La, Sm, Gd and Yb. Also, examples of the reducing organic compounds include nitrogen-containing compounds, sulfur-containing compounds and phosphorus-containing compounds.

In addition, there may be used materials described in, for example, JP-A Nos. 06-212153, 2000-196140, 2003-68468, 2003-229278 and 2004-342614.

These electron donating dopants may be used alone or in combination. The amount of the electron donating dopant used depends on the type of the material, but it is preferably 0.1% by mass to 99% by mass, more preferably 1.0% by mass to 80% by mass, particularly preferably 2.0% by mass to 70% by mass, with respect to the amount of the material of the electron transport layer.

The thicknesses of the electron-injection layer and the electron-transport layer are each preferably 500 nm or less in terms of reducing drive voltage.

The thickness of the electron-transport layer is preferably 1 nm to 500 nm, more preferably 5 nm to 200 nm, particularly preferably 10 nm to 100 nm. The thickness of the electron-injection layer is preferably 0.1 nm to 200 nm, more preferably 0.2 nm to 100 nm, particularly preferably 0.5 nm to 50 nm.

Each of the electron-injection layer and the electron-transport layer may have a single-layered structure made of one or more of the above-mentioned materials, or a multi-layered structure made of a plurality of layers which are identical or different in composition.

### <<<<<Hole Blocking Layer>>>>>

The hole blocking layer is a layer having the function of preventing the holes, which have been transported from the anode side to the light-emitting layer, from passing toward the cathode side, and may be provided as an organic compound layer adjacent to the light-emitting layer on the cathode side.

Examples of the compound forming the hole blocking layer include aluminum complexes (e.g., bis-(2-methyl-8-quinolinolate)-4-(phenylphenolate)aluminum (BAlq)), triazole derivatives and phenanthroline derivatives (e.g., BCP).

The thickness of the hole blocking layer is preferably 1 nm to 500 nm, more preferably 5 nm to 200 nm, particularly preferably 10 nm to 100 nm.

The hole blocking layer may have a single-layered structure made of one or more of the above-mentioned materials, or a multi-layered structure made of a plurality of layers which are identical or different in composition.

### <<<<<Electron Blocking Layer>>>>>

An electron blocking layer is a layer having the function of preventing the electrons, which have been transported from the cathode side to the light-emitting layer, from passing toward the anode side, and may be provided as an organic compound layer adjacent to the light-emitting layer on the anode side in the present invention.

Examples of the compound forming the electron blocking layer include those listed as a hole-transport material.

The thickness of the electron blocking layer is preferably 1 nm to 500 nm, more preferably 5 nm to 200 nm, particularly preferably 10 nm to 100 nm

The electron blocking layer may have a single-layered structure made of one or more of the above-mentioned materials, or a multi-layered structure made of a plurality of layers which are identical or different in composition.

### <<<<Driving>>>>

The organic EL element can emit light when a DC voltage (which, if necessary, contains AC components) (generally 2 volts to 15 volts) or a DC is applied to between the anode and the cathode.

For the driving method of the organic EL layer, applicable are those described in, for example, JP-A Nos. 02-148687, 06-301355, 05-29080, 07-134558, 08-234685 and 08-241047, Japanese Patent No. 2784615, and U.S. Pat. Nos. 5,828,429 and 6,023,308.

The organic EL element may have the structure in which charge-generation layers are provided between a plurality of light-emitting layers for the purpose of further enhancing the light-emission efficiency.

The charge-generation layer has the function of generating charges (holes and electrons) during application of an electric field as well as the function of injecting the generated charges into the adjacent layer to the charge-generation layer.

The charge-generation layer is made of any material, so long as it has the above-described functions. Also, it may be made of a single compound or a plurality of compounds.

Specifically, the material may be conductive materials, semi-conductive materials (like doped organic layers) or insulating materials. Specific examples thereof include those disclosed in, for example, JP-A Nos. 11-329748, 2003-272860 and 2004-39617.

More specific examples thereof include transparent conductive materials such as ITO and indium zinc oxide (IZO); fullerenes such as C₆₀; conductive organic compounds such as thiophene oligomers; conductive organic compounds such as metal phthalocyanines, metal-free phthalocyanines, metal porphyrins and metal-free porphyrins; metal materials such as Ca, Ag, Al, Mg—Ag alloy, Al—Li alloy and Mg—Li alloy; hole conductive materials; electron conductive materials; and mixtures thereof.

Examples of the hole conductive material include hole transport organic materials (e.g., 2-TNATA and NPD) doped with oxidants having electron attracting properties (e.g., F4-TCNQ, TCNQ and FeCl₃), P-type conductive polymers and P-type semiconductors. Examples of the conductive material include the electron transport organic materials doped with metals or metal compounds having a work function of less than 4.0 eV, N-type conductive polymers and N-type semiconductors. Examples of the N-type semiconductor include N-type Si, N-type CdS and N-type ZnS. Examples of the P-type semiconductor include P-type Si, P-type CdTe and P-type CuO.

Further, for forming the charge-generation layer, an insulating material such as V₂O₅ may be used.

The electric charge-generation layer may have a single-layered structure or be a laminate of a plurality of layers. Examples of the laminate include laminates of hole or electron conductive material and conductive materials (e.g., a transparent conductive material and a metal material); and a laminate of the hole and electron conductive materials.

In general, preferably, the film thickness or the material of the charge-generation layer can be selected so that the transmittance with respect to a visible light is 50% or more. The film thickness is not particularly limited and may be appropriately determined depending on the purpose. It is preferably 0.5 nm to 200 nm, more preferably 1 nm to 100 nm, still more preferably 3 nm to 50 nm, particularly preferably 5 nm to 30 nm.

The method for forming the charge-generation layer is not particularly limited, and the above-described method for forming the organic compound layer can also be employed.

The charge-generation layer is formed between two or more of the light-emitting layer. Also, a material having the function of injecting charges may be incorporated into the adjacent layers to the charge-generation layer on the anode and cathode sides. In order to increase injection properties of electrons into the adjacent layer on the anode side, electron-injecting compounds such as BaO, SrO, Li₂O, LiCl, LiF, MgF₂, MgO and CaF₂ may be laminated on a surface of the charge-generation layer which faces the anode.

Other than the materials described above, the material for the charge-generation layer may be selected based on the description in, for examples, JP-A No. 2003-45676 and U.S. Pat. Nos. 6,337,492, 6,107,734 and 6,872,472.

The organic EL layer may have a resonator structure. For example, on a transparent substrate are stacked a multi-layered film mirror composed of a plurality of laminated films having different reflective indices, a transparent or semi-transparent electrode, a light-emitting layer and a metal electrode. The light generated in the light-emitting layer is repeatedly reflected between the multi-layered film mirror and the metal electrode (which serve as reflection plates); i.e., is resonated.

In another preferred embodiment, a transparent or semi-transparent electrode and a metal electrode are stacked on a transparent substrate. In this structure, the light generated in the light-emitting layer is repeatedly reflected between the transparent or semi-transparent electrode and the metal electrode (which serve as reflection plates); i.e., is resonated.

For forming the resonance structure, an optical path length determined based on the effective refractive index of two reflection plates, and on the refractive index and the thickness of each of the layers between the reflection plates is adjusted to be an optimal value for obtaining a desired resonance wavelength. The calculation formula applied in the case of the first embodiment is described in JP-A No. 09-180883. The calculation formula in the case of the second embodiment is described in JP-A No. 2004-127795.

### <<Substrate>>

The substrate may be appropriately selected depending on the purpose without particular limitation, and is preferably those which do not diffuse or damp light emitted from an organic compound layer. Examples of the materials for the substrate include inorganic materials such as yttria-stabilized zirconia (YSZ) and glass; and organic materials such as polyesters (e.g., polyethylene terephthalate, polybutylene phthalate and polyethylene naphthalate), polystyrene, polycarbonate, polyether sulfone, polyarylate, polyimide, polycycloolefin, norbornene resins and poly(chlorotrifluoroethylene).

For example, when the substrate is made of glass, the glass is preferably alkali-free glass in order to reduce ions eluted from it. Also, when soda-lime glass is used for the material of the substrate, a barrier coat of silica, etc., is preferably provided on the substrate. The organic materials are preferably used since they are excellent in heat resistance, dimensional stability, solvent resistance, electrical insulation and processability.

The shape, structure, size, etc. of the substrate are not particularly limited and may be appropriately selected depending on, for example, the application/purpose of the formed light-emitting element. In general, the shape thereof is preferably a sheet shape. The substrate may have a single- or multi-layered structure, and may be a single member or a combination of two or more members.

The substrate may be colorless or colored transparent. It is preferably colorless transparent, since such colorless transparent substrate does not diffuse or damp light emitted from an organic light-emitting layer.

The substrate may be provided with a moisture permeation-preventing layer (gas barrier layer) on the front or back surface thereof.

The moisture permeation-preventing layer (gas barrier layer) is preferably made from an inorganic compound such as silicon nitride and silicon oxide, and may be formed through, for example, high-frequency sputtering.

When a thermoplastic substrate is used, a hard coat layer, an under coat layer and other layers may be additionally provided as necessary.

### EXAMPLES

The present invention will next be described by way of examples, which should not be construed as limiting the present invention thereto.

### Example 1

A light-emitting device of Example 1 was fabricated as follows.

### <Formation of Optical Sheet>

First, titanium oxide (volume average particle diameter: 20 nm) was dispersed in an acrylic photocurable resin at a concentration of 30% by volume. An 80-μm thick polyethylene terephthalate film was coated through extrusion coating with the resultant dispersion so that the coated product had a thickness of 20 μm.

Next, there was provided a Ni mold having in its surface a concavo-convex pattern in which the pitch P (FIG. 8) is 800 nm and the aspect ratio X/Y of the convex portion is 0.8. While the mold was being pressure-molded to the photocurable resin in which titanium oxide had been dispersed, the photocurable resin was irradiated with UV rays from the side of the polyethylene terephthalate film for 1 minute, to thereby form a second layer having a refractive index of about 1.8.

Next, a 50-nm Ag thin film was formed on the second layer through DC sputtering.

Further, the Ag thin film was coated through extrusion coating with a photocurable resin so that the coated product had a thickness of 20 μm. The photocurable resin was irradiated with UV rays for 1 minute while being pressure-bonded to a smooth substrate so that concave and convex portions do not remain in the surface, to thereby form, over the second layer, a first layer having a concavo-convex pattern whose pitch P is 800 nm.

### <Transfer of Optical Sheet to Substrate>

The thus-produced optical sheet was transferred onto a 0.7-mm thick glass substrate so that the first layer faced the glass substrate, and then the polyethylene terephthalate film was peeled off.

Thereafter, the substrate surface was subjected to plasma treatment in order to improve adhesion between the glass substrate and the optical sheet (first layer).

### <Fabrication of Organic EL Element>

An organic EL element was fabricated as follows using a resistance-heating vacuum evaporation apparatus.

A 70-nm thick indium tin oxide (ITO) layer was formed as an anode on the second layer of the optical film which had been transferred onto the glass substrate.

A 160-nm thick hole-injection layer was formed on the ITO layer by co-evaporating 4,4′,4″-tris(2-naphthylphenylamino)triphenylamine (which is abbreviated as “2-TNATA,” refer to the following structural formula) and tetrafluorotetracyanoquinodimethane (which is abbreviated as “F4-TCNQ,” refer to the following structural formula) so that the amount of F4-TCNQ was 1.0% by mass with respect to 2-TNATA.

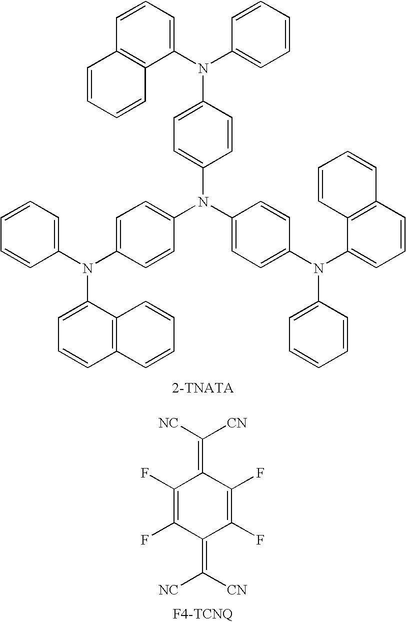

A 10-nm thick hole transport layer was formed on the hole injection layer using N,N′-dinaphthyl-N,N′-diphenyl-[1,1′-biphenyl]-4,4′-diamine (which is abbreviated as “α-NPD,” refer to the following structural formula).

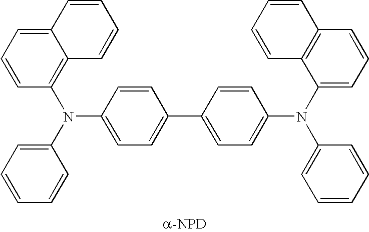

A 30-nm thick organic light-emitting layer was formed on the hole transport layer by co-evaporating 1,3-bis(carbazol-9-yl)benzene (which is abbreviated as “mCP,” refer to the following structural formula) and green light-emitting material tris(2-phenylpyridine)iridium (which is abbreviated as “Ir(ppy)₃,” refer to the following structural formula) so that the amount of the green light-emitting material was 5% by mass with respect to mCP. The refractive index of the organic light-emitting layer was found to be 1.9.

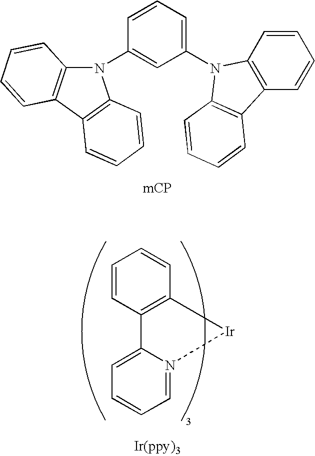

Subsequently, a 40-nm thick electron transport layer was formed on the organic light-emitting layer using bis-(2-methyl-8-quinolinolate)-4-(phenylphenolate) aluminum (which is abbreviated as “BAlq,” refer to the following structural formula).

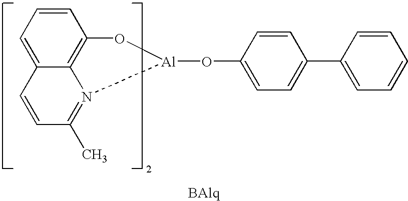

Further, patterning was performed using a shadow mask to form a 1-nm thick LiF layer, a 2-nm thick Al layer and a 100-nm thick ITO layer.

### <Seal Layer>

A seal layer was formed on the organic EL element using a mixture of SiNₓ and SiOₓ. The refractive index of the seal layer was found to be about 1.9.

### Example 2

The procedure of Example 1 was repeated, except that the pitch P of the concavo-convex pattern formed in the first layer was changed from 800 μm to 400 μm, to thereby fabricate a light-emitting device of Example 2.

### Example 3

The procedure of Example 1 was repeated, except that the pitch P of the concavo-convex pattern formed in the first layer was changed from 800 μm to 2,000 μm, to thereby fabricate a light-emitting device of Example 3.

### Example 4

The procedure of Example 1 was repeated, except that the refractive index of the second layer was changed from 1.8 to 1.7 by changing the concentration by volume of titanium oxide from 30% to 20%, to thereby fabricate a light-emitting device of Example 4.

### Example 5

The procedure of Example 1 was repeated, except that the refractive index of the second layer was changed from 1.8 to 1.6 by changing the concentration by volume of titanium oxide from 30% to 10%, to thereby fabricate a light-emitting device of Example 5.

### Example 6

The procedure of Example 1 was repeated, except that the refractive index of the second layer was changed from 1.8 to 1.5 by changing the concentration by volume of titanium oxide from 30% to 0%, to thereby fabricate a light-emitting device of Example 6.

### Comparative Example 1

The procedure of Example 1 was repeated, except that an organic EL element was directly formed on the glass substrate without forming the optical sheet thereon, to thereby form a light-emitting device of Comparative Example 1.

### <Measurement Method>

### <<Refractive Index>>

The refractive index of each layer was measured through ellipsometry with an Abbe refractometer (product of ATAGO CO., LTD.).

### <<Pitch of Concavo-Convex Pattern>>

The pitch of the concavo-convex pattern was measured with an AFM (product name: OLS3500, product of Olympus Corporation). Here, the pitch of the concavo-convex pattern is a length of P shown in FIG. 8.

### <<Aspect Ratio of Convex Portion in Concavo-Convex Pattern>>

The aspect ration of the convex portion in the concavo-convex pattern was measured with an AFM (product name: OLS3500, product of Olympus Corporation). Here, the aspect ratio of the convex portion in the concavo-convex pattern is an average value of ratios X/Y of the heights X to the widths Y of 10 convex portions (see FIG. 8).

### <<Light-Extraction Efficiency>>

The fabricated light-emitting element was evaluated in terms of light-extraction efficiency by the following method.

The light quantity (Q₂) of each of the light-emitting elements of Examples 1 to 6 was compared with the light quantity (Q₁) of the light-emitting element of Comparative Example 1 (regarded as 1), and was evaluated on the basis of the ratio Q₂/Q₁. The results are shown in Table 1.

### <<Light Quantity>>

The light emitted from the fabricated light-emitting element was measured with a multichannel spectrometer (product of Ocean Photonics).

Notably, the main light wavelength of the light emitted from the fabricated light-emitting element was measured with a multichannel spectrometer (product of Ocean Photonics).

TABLE 1

| | Refractive | Pitch P of | Aspect ratio | Light- |
|---|---|---|---|---|
| | index of | concave-convex | of convex | extraction |
| | second layer | pattern (nm) | portion | efficiency |
| Ex. 1 | 1.8 | 800 | 0.8 | 1.6 |
| Ex. 2 | 1.8 | 400 | 0.8 | 1.4 |
| Ex. 3 | 1.8 | 2,000 | 0.8 | 1.2 |
| Ex. 4 | 1.7 | 800 | 0.8 | 1.4 |
| Ex. 5 | 1.6 | 800 | 0.8 | 1.2 |
| Ex. 6 | 1.5 | 800 | 0.8 | 1.1 |
| Comp. Ex. 1 | — | — | — | 1.0 |

In the above Examples, the light-extraction efficiency was found to be the highest when the pitch P of the concavo-convex pattern was 800 nm. Regarding the light-emitting efficiency, the optimal pitch P depends on the device structure or the light-emitting material. The pitch P suitable to the device structure or the material must be selected appropriately. Notably, when the pitch P is too great, the light-emitting efficiency decreases.

Also, the smaller the difference in refractive index between the second layer and the light-emitting layer, the higher the light-extraction efficiency.

The optical sheet of the present invention can be suitably used in light-emitting devices such as display devices, displays (light-emitting-type flat panel displays (organic EL, inorganic EL, plasma)), backlights, electrophotography, illuminating light sources, recording light sources, exposing light sources, reading light sources, markers, interior accessories, optical communication, LEDs and fluorescent tubes.

What is claimed is:

1. An optical sheet comprising:
a first layer having a concavo-convex pattern which reflects light, and
a second layer laminated over the concavo-convex pattern and made of a light-transmissive material,
wherein the optical sheet is disposed opposite to a light-emitting surface of a light-emitting element.

2. The optical sheet according to claim 1, wherein the difference in refractive index between the second layer and a light-emitting layer of the light-emitting element is within 0.3.

3. The optical sheet according to claim 1, wherein the pitch of the concavo-convex pattern is 100 nm to 5,000 nm.

4. The optical sheet according to claim 1, wherein the second layer contains a is metal oxide dispersed therein.

5. The optical sheet according to claim 1, wherein the aspect ratio of convex portions in the concavo-convex pattern is 0.1 to 4.0.

6. The optical sheet according to claim 1, further comprising a support film disposed on the outer surface of the second layer.

7. A method for producing an optical sheet, the method comprising:
coating a support film with a curable resin which is a light-transmissive material,
forming a second layer by curing the curable resin while a mold having a concavo-convex pattern in a surface thereof is being pressure-bonded to the curable resin, and
forming a first layer by forming a thin film of a reflective material on the second layer,
wherein the optical sheet comprises the first layer having the concavo-convex pattern which reflects light, and the second layer made of a light-transmissive material, and
wherein the optical sheet is disposed opposite to a light-emitting surface of a light-emitting element.

8. The method according to claim 7, wherein the support film is a belt-like film and the mold is a first roll mold having a concavo-convex pattern in an outer circumferential surface thereof, and wherein, in the coating, the belt-like film is continuously coated with the curable resin and, in the forming the second layer, the belt-like film which has been coated with the curable resin is wound around the first roll mold.

9. The method according to claim 8, further comprising forming a laminate containing the first layer by coating a surface of the thin film with a resin-containing coating liquid, wherein, in the forming the laminate, the belt-like film is provided with a thin film of a reflective material and wound around a second roll mold having a smooth outer circumferential surface which has been coated with the resin-containing coating liquid.

10. A method for producing an optical sheet, the method comprising:
forming a first layer by forming a concavo-convex pattern in a light-reflective sheet superposed on and thermally pressure-bonded to a surface of a mold having the concavo-convex pattern, and
forming a second layer by coating a surface of the first layer with a resin-containing coating liquid containing a resin as a light-transmissive material,
wherein the optical sheet comprises the first layer having the concavo-convex pattern which reflects light, and the second layer made of the light-transmissive material, and
wherein the optical sheet is disposed opposite to a light-emitting surface of a light-emitting element.

11. The method according to claim 10, wherein the light-reflective sheet is a belt-like sheet and the mold is a first roll mold having a concavo-convex pattern in an outer circumferential surface thereof, and wherein, in the forming the first layer, the belt-like sheet is wound around the first roll mold and continuously provided with a concavo-convex pattern to thereby form the first layer and, in the forming the second layer, a surface of the first layer is continuously coated with the resin-containing coating liquid.

12. The method according to claim 11, wherein, in the forming the second layer, the belt-like film is wound around a second roll mold having a smooth outer circumferential surface which has been coated with the resin-containing coating liquid.

13. The method according to claim 10, further comprising attaching a support film to the second layer.

14. A method for producing an optical sheet, the method comprising:
forming a concavo-convex pattern in a surface of a support film while a mold having the concavo-convex pattern is being pressure-bonded to the surface of the support film,
forming a first layer by forming a thin film of a reflective material on the concavo-convex pattern, and
forming a second layer by coating a surface of the first layer with a resin-containing coating liquid containing a resin as a light-transmissive material,
wherein the optical sheet comprises the first layer having the concavo-convex pattern which reflects light, and the second layer made of the light-transmissive material, and
wherein the optical sheet is disposed opposite to a light-emitting surface of a light-emitting element.

15. The method according to claim 14, wherein the support film is a belt-like film and the mold is a first roll mold having a concavo-convex pattern in an outer circumferential surface thereof, and wherein, in the forming the concavo-convex pattern, the belt-like film is wound around the first roll mold and continuously provided with a concavo-convex pattern and, in the forming the first layer, a thin film of a reflective material is formed on the concavo-convex pattern to thereby form the first layer.

16. The method according to claim 15, wherein, in the forming the second layer, the belt-like film is wound around a second roll mold having a smooth outer circumferential surface which has been coated with the resin-containing coating liquid.

17. The method according to claim 14, further comprising attaching a support film to the second layer.
